(19) United States
(12) Patent Application Publication
(10) Pub. No.: US 2018/0330287 A1
(43) Pub. Date: Nov. 15, 2018

(54) SYSTEM AND METHOD TO MONITOR AND CONTROL WORKFLOW

(71) Applicant: NEXUS ENVIRONMENTAL, LLC, Miami Beach, FL (US)

(72) Inventor: Pradeep R. Tripathi, Miami Beach, FL (US)

(21) Appl. No.: 16/042,569

(22) Filed: Jul. 23, 2018

Related U.S. Application Data
(63) Continuation of application No. 13/622,849, filed on Sep. 19, 2012.
(60) Provisional application No. 61/536,834, filed on Sep. 20, 2011.

(51) Int. Cl. G06Q 10/06

(52) U.S. Cl. CPC G06Q 10/06

(57) ABSTRACT

A workflow evaluation system includes (i) a camera located at a facility, the camera positioned to record video data of multiple instances of a procedure involving an action performed on a workpiece, the action involving a physical movement; (ii) a database storing at least one workflow rule concerning the procedure, at least one of the workflow rules involving the physical movement of the action performed on the workpiece; and (iii) a procedure monitoring processor communicatively coupled to the database and configured to access the at least one workflow rule involving the physical movement of the action performed on the workpiece, compare corresponding physical movement information obtained from the video data of one of the multiple instances of the procedure to the accessed at least one workflow rule, and send a non-satisfy message if the compared corresponding physical movement information does not satisfy the accessed at least one workflow rule.

### PRIORITY CLAIM

This application claims priority to and the benefit as a continuation of U.S. patent application Ser. No. 13/622,849, filed Sep. 19, 2012, entitled Method and Apparatus to Monitor and Control Workflow, which claims priority to and the benefit of U.S. Provisional Patent Application Ser. No. 61/536,834, filed Sep. 20, 2011, entitled “Method and Apparatus to Monitor and Control Work Flow”, the entire contents of each of which are hereby incorporated by reference and relied upon.

### BACKGROUND

Many processes are performed by personnel following specified workflows. These workflows provide specific instructions of actions to be sequentially performed so that a process can be finished efficiently and effectively. In manufacturing environments, workflows provide coordinated process steps to ensure that a product is properly manufactured. In process control environments, workflows provide instructions to ensure a process operates continuously without deviations. In inspection and validation environments, workflows provide a series of tests to ensure that a product conforms to one or more standard.

In an example, vehicle inspection facilities test vehicles according to jurisdictional (e.g., city, state, country) standards. The tests can include any number of safety and/or emissions procedures (e.g., brake tests, suspension tests, speedometer tests, sound level tests, smoke emission tests, etc.) to validate that a vehicle is safe to operate on public roadways.

Many jurisdictions, including states, cities, countries, etc., have vehicle inspection stations to ensure that passenger and/or commercial vehicles are safe for roadways and conform to emission and/or safety standards. The jurisdictions, including states, cities, countries, etc., have mandated regulated programs to ensure passenger and/or commercial vehicles are safe for roadways and conform to emission and/or safety standards. Vehicle inspectors are trusted to perform specified safety and/or emission inspections per the prevailing rules and regulations for the corresponding jurisdiction.

Inspectors are trusted to perform vehicle inspections according to standards mandated by a jurisdiction. However, there are many documented cases of inspectors performing substandard inspections to save time and/or money. While the majority of inspectors perform proper inspections, the few inspectors that pass vehicles without conducting a proper inspection allow vehicles with undiscovered defects to remain on public roads.

To identify inspectors that do not perform proper inspections, many jurisdictions use auditors. These auditors periodically visit the inspection stations within the jurisdiction to ensure that the inspectors are following the specified standards. In some instances, the auditors pose as regular drivers and use a test vehicle with known defects to determine if the inspectors perform the required tests. While these auditors are effective in identifying problematic inspectors, the limited number of auditors results in some inspection facilities being audited only once every few years. Between audits, some inspectors may conduct substandard inspections. More importantly, auditors spend a significant amount of time auditing inspectors that perform proper inspections due lack of supporting data to identify problem inspectors.

Auditing an inspection station is a relatively time consuming process because auditors have to travel to the stations, perform the audit, and draft a report of the audit. Additionally, with government budget cuts, there are relatively few auditors compared to the large number of inspection stations. Further, auditing only provides a sample or snapshot of the performance of an inspection station. These known issues can result in auditors failing to timely identify problematic inspection stations, thereby resulting in vehicles with safety and/or emission defects remaining on public roads.

To facilitate audits, some jurisdictions have implemented video surveillance systems that monitor inspectors. However, these systems require one or more auditor to watch numerous hours of video over multiple inspection facilities to detect substandard inspections. In other instances, the video is only reviewed after a complaint from a customer is received. While video surveillance systems exist, the relatively large amount of video captured can be too much for a team of auditors to cost effectively and consistently monitor.

There is accordingly a need for improved systems and methods for monitoring and controlling automotive testing facilities as well as other manufacturing and service industries subject to quality control.

### SUMMARY

The present disclosure relates generally to monitoring and/or controlling workflow for the purpose of increasing work quality, productivity, and consistency. More specifically, the present disclosure relates to: monitoring movements of individuals and/or objects during work processes; determining if the work process is within quality parameters; controlling the workflow where desired or needed; flagging any out of boundary condition for review and/or auditing; and using population data to determine normal operating behaviors. These methods and associated systems can be applied to many different industries and disciplines. To illustrate the systems and methods, an automotive testing environment has been chosen. It should be appreciated however that it is expressly contemplated to apply the principles and advantages of the automotive testing example to other industrial and service applications, such as any type of manufacturing line, retail operation, restaurant operation such as fast food restaurants, and medical application such as for detecting sleep disorders.

The example systems and methods described herein attempt to solve the known workflow control and monitoring issues by providing a workflow auditing system that, in the automotive testing example, detects the movement and/or positioning of inspectors, vehicles and other objects and compares this information to predetermined acceptable movements and/or positioning (e.g., workflow rules) specified for procedure(s) or test(s) of an inspection. The example workflow auditing systems and methods of the present disclosure receive recorded data from one or more camera system in an inspection facility and perform video processing on the images to identify actions performed (e.g., workflow data) by the inspectors. The example workflow auditing system then compares the identified actions to workflow rules specified according to a pre-defined procedure or inspection protocol. If an inspector action deviates from a workflow rule, the example workflow auditing system can flag the action of the inspector for further review by an auditor (e.g., monitor) and/or restrict the inspector from finishing the procedure (e.g., control) until the specified action is performed. In other examples, the workflow auditing system can perform statistical and/or modal analysis to determine if the detected action of an inspector is within a specified distribution and/or deviation from population statistics and/or other specified allowable or disallowed actions. In these other examples, the distribution of “normal” or allowable actions may be determined by, for example, an average and standard deviation of motions of the population of inspectors performing the same inspection.

As described herein, actions performed by an inspector are quantified as workflow data for processing by the example workflow auditing system. The workflow data includes, for example, a time duration of an action performed by an inspector, a spatial position of an inspector, a function (e.g., a portion of an inspection procedure) performed by the inspector, or a motion characteristic (e.g., bodily movement) of the inspector. Each portion of workflow data has predetermined workflow limits that correspond to the procedure being performed. As can be appreciated, a single inspection procedure can include multiple workflow limits for different types or sequences of workflow data.

The example workflow auditing system disclosed herein may be local at each inspection facility or, alternatively, may be centralized in a management server or an audit facility. In other examples, the local workflow auditing system may perform real-time analysis and/or provide process control to ensure that an inspector completes an inspection properly, while the centralized workflow auditing system may perform a statistical analysis of received workflow data to determine if an inspector and/or an inspection facility should be audited. In these examples, the workflow auditing system may include any one or more computer, server, processor, memory, routines, algorithms, and/or functions to monitor inspectors.

The example systems and methods described herein use motion capture technology to record actions performed by inspectors. In an example, an inspection facility includes a camera system mounted some distance above a vehicle to provide a plan view of an inspection area of the facility. In other examples, an inspection facility may include multiple camera systems (e.g., camera systems at a front and a rear location of an inspection facility).

The example camera system includes a camera and a depth sensor in one embodiment. In some examples, the camera system may be implemented by Microsoft Corporation's Kinect™. The camera may include any type of camera for capturing a video image. For example, the camera may include a red-green-blue (“RGB”) camera, an enhanced video camera, a megapixel digital video camera, and/or an analog closed circuit camera. The example camera can be controlled by, for example, the example workflow auditing system. In these examples, the auditing system can control zoom, tilt, and/or pan functions of the camera. In other examples, the workflow auditing system can specify a shutter speed (e.g., 200 frames per second) based on a desired motion to be captured. In yet other examples, the workflow auditing system can follow an inspector and/or vehicle to different inspection positions (e.g., other locations within an inspection facility).

The example depth sensor includes any light projector and/or light sensor to determine a distance of objects (e.g., inspectors) from the camera system. The depth sensor may also determine relative positioning of distances between objects and/or the operator (operator as used herein can be, but is not limited to, an inspector, manufacturing person, service person, medical person, delivery person, office person, or any person performing a task in any type of industrial setting). For example, the depth sensor could determine that an inspector is 20 feet (six meters) away from the sensor and is 2.5 feet (0.92 meter) away from a left corner of a vehicle.

In an example, the depth sensor includes an infrared laser projector that transmits a laser grid at a frame rate of thirty (30) Hertz (“Hz”). Other frequencies can be used however. Alternatively or additionally, the laser projector may transmit any other suitable light pattern including, for example, points, check-board patterns, circular patterns, etc. In other examples, the depth sensor uses light projectors for time-of-flight, interferometry, coded aperture, and/or light triangulation depth sensing techniques.

The example depth sensor also includes a light sensor to detect reflections of the transmitted light patterns from the light projector. In some examples, the light sensor includes a monochrome complementary metal-oxide-semiconductor (“c-MOS”) (e.g., an Active Pixel Sensor (“APS”)) or charged coupled device (“CCD”) sensor, which captures video data in three-dimensions under ambient light conditions. The light sensor may be calibrated based on the layout of an inspection station and/or a positioning of the camera system within the inspection station.

The example camera system may also include a microphone (e.g., a multi-array microphone) for personnel monitoring and/or for detecting audio control commands from an inspector. The example microphone can include sound sensor and/or noise filtering components. In some instances the microphone may be used for voice recognition functions (e.g., inspector authentication) and/or the verification of safety and/or emission testing. For example, the microphone can be used to detect engine noise to ensure an inspector started a vehicle engine to complete an engine test. The use of the microphone in this instance not only serves a quality assurance purpose, the microphone also eliminates an input by the operator. That is, the operator does not have to check off that the engine has been started, the system does so automatically. In another example, the microphone may detect an audio output (e.g., speech or voice output) from an inspector indicating a test has passed. A local workflow auditing system may then decipher the audio and record the test as being passed.

The example depth sensor and/or the example camera transmit recorded data to the example workflow auditing system. The workflow auditing system may at least be partially located within an inspection facility and integrated into the inspection test system. Here, the workflow auditing system performs localized motion capture processing that is integrated with the inspection tests. For example, the workflow auditing system may perform process control functions by not allowing an inspector to complete a test until workflow data satisfies a corresponding workflow rule.

In another example, the workflow auditing system may use visual signals, such as gestures or colored shapes, and/or audio signals from inspectors to confirm the result of an inspection test (e.g., confirming upon detecting that an inspector is displaying a green card or providing a ‘thumbs up’ to indicate the current test has a pass result). In another example, the system's detection of the operator raising his/her arm signals that the test procedure has been passed, while pointing the arm downwardly signals that the test procedure has failed. Pointing the operator's arm to the operator's left can be used as a signal that a structure on the left side of the car, e.g., a left-rear taillight is being tested. Pointing to the right indicates that a structure on the right side of the car, e.g., a right-rear taillight is being tested.

Inspectors often use tools while performing an inspection. The tools used by the operators may be marked, tagged or otherwise made identifiable so that the tools can be identified and/or so that a particular use of the tool can be monitored and logged. For example, an inspector's wrench can be identified by having a red end and a blue end. A turning of the wrench can be identified by the detection of the red and blue ends both striking a same arc about a common center point. In another example, an inspector's screwdriver is provided with a handle having a distal end cap that is half black and half white. Turning of the screwdriver is confirmed by the detection of a rotation of the white and black halves about a center point at the axis or rotation of the screwdriver. A tool can be identified by shape or by a particular logo or indicia placed on the tool. Identification is accordingly not limited to color.

In other examples, the local workflow auditing system disclosed herein may transmit workflow data to a centralized workflow auditing system (e.g., a centralized management server and database) to perform inspector and/or auditing. In these other examples, the centralized auditing system may use any statistical model to determine how a detected motion and/or audio deviates from a normal distribution of acceptable motion and/or audio. In these examples, the inspector may be flagged for an audit if the inspector's detected motions fall outside of a specified statistical deviation. Additionally, the workflow auditing system may selectively store a record of this deviation. In some examples, the workflow auditing system may then determine if an inspector and/or an inspection facility has accrued a threshold number of deviation records (e.g., violations) to warrant an audit.

The example workflow auditing systems and methods disclosed herein may be located at a centrally located audit facility that receives recorded or analyzed workflow data from multiple inspection stations. In these examples, the camera systems transmit recorded data in real time and/or at periodic time intervals to the workflow auditing system. The workflow auditing system may use data from multiple inspection facilities to identify a “normal” distribution of inspector motions for each test in an inspection.

The example workflow auditing system disclosed herein uses workflow algorithms and/or routines to convert recorded data from a camera and/or a depth/color sensor into digitalized workflow data for analysis. In these examples, the workflow auditing system calculates workflow data for each frame of recorded data. In some examples, the workflow auditing system may reconstruct the individual frames into a video sequence so that auditors can review the data in a ‘movie’ format. Additionally, the workflow auditing system may compare groups of frames in a video sequence to one or more workflow rule to determine a length of time an inspector has performed an action or function and/or has been located in a particular area.

In some examples, the example workflow auditing system uses depth sensor data to construct a two-dimensional representation of recorded images using color to show a relative distance of objects from the camera system. In these examples, the workflow auditing system calculates a distance to each object in physical units (e.g., meters) based on the two-dimensional distance data. The example workflow auditing system may also calculate relative distances between objects. The workflow auditing system then compares the distance data of one or more frames of data of the identified objects to different inspection workflow rules to determine if an inspection procedure has been performed properly.

In other examples, the workflow auditing system may use pixilated digitalized data from a depth sensor to calculate a physical distance of an image within each pixel from the camera system (e.g., as described in the publication titled “Real-Time Human Pose Recognition in Parts from Single Depth Images,” by Microsoft Research Cambridge & Xbox Incubation, the entire contents of which are incorporated herein by reference, are made a part hereof and are relied upon). In these other examples, the workflow auditing system embeds distance data within each pixel as, for example, metadata, and reconstructs the pixels using the distance data. The workflow auditing system constructs objects with similar distances and proximities. The example workflow auditing system may then use a decision algorithm to determine if the constructed image is an inspector and/or an item being used by an inspector. The workflow auditing system may also use decision algorithms to identify joints and/or movement positions of the objects to provide a finer granularity of identified actions. Further, the workflow auditing system may use facial recognition processing, color matching and/or radio frequency identification (“RFID”) processing to identify an inspector. In these other examples, the camera system may include RFID transceivers and/or high resolution facial recognition cameras.

After constructing objects from the recorded data, the example workflow auditing system compares the objects in the workflow data to one or more workflow rules for each inspection procedure. The workflow auditing system incorporates the workflow rules into the workflow data and compares a sequence of captured video frames to the workflow rules. In some examples, the workflow rules may specify that an object (e.g., the inspector) is to be in a certain area for a minimum amount of time for an average inspector to complete a test (e.g., 50 seconds to remove a tire to inspect the brakes). In other examples, the workflow rules may specify that an inspector is to move to a certain point within an inspection station to complete a procedure. For example, a workflow rule may specify that an inspector is to cross a plane perpendicular to a tail light of a vehicle to ensure the inspector was within viewing distance of the light.

The workflow auditing system overlays the distance data with the camera images to enable auditors to monitor inspectors and compare their actions to the rules for each inspection procedure or test. For example, a procedure by an inspector to remove rear tires of a vehicle is flagged by the workflow auditing system. An auditor can retrieve the stored data to review the video of the inspector performing the test with an overlay of boundaries, limits, and/or thresholds of the workflow rules for performing an inspection of the rear tires.

It is accordingly an advantage of the present disclosure to provide improved systems and methods for industrial or service process monitoring, control and/or auditing.

It is another advantage of the present disclosure to improve industrial or service process monitoring, control and/or auditing using video and/or audio feedback.

It is a further advantage of the present disclosure to monitor, control and/or audit an industrial or service process using digitalized motion capturing that provides data that can be analyzed and manipulated.

It is yet another advantage of the present disclosure to improve vehicle emissions testing.

Additional features and advantages are described herein, and will be apparent from the following Detailed Description and the figures.

### BRIEF DESCRIPTION OF THE FIGURES

FIGS. 1A to 1D illustrate an example workflow auditing system of the present disclosure including inspection facilities, audit facilities, and a management center.

FIGS. 2 to 4 illustrate a plan view of one embodiment of an inspection facility including a camera system.

FIGS. 5 and 6 illustrate example video frames of an inspector inspecting a vehicle according to an embodiment of the system and method of the present disclosure.

FIGS. 7 to 9 illustrate example inspection control panels, which are used by an inspector to conduct a vehicle inspection.

FIGS. 10A, 10B, and 11 are flowcharts according to an embodiment of the present disclosure representative of machine-accessible instructions, which may be executed to implement the workflow auditing system of FIGS. 1A to 4.

FIG. 12 is a schematic illustration of an example processor platform according to an embodiment of the present disclosure, which may be used and/or programmed to execute the example processes and/or the example machine-accessible instructions of FIGS. 10A, 10B and 11 to implement any or all of the example methods, apparatus and/or articles of manufacture described herein.

### DETAILED DESCRIPTION OF THE DRAWINGS

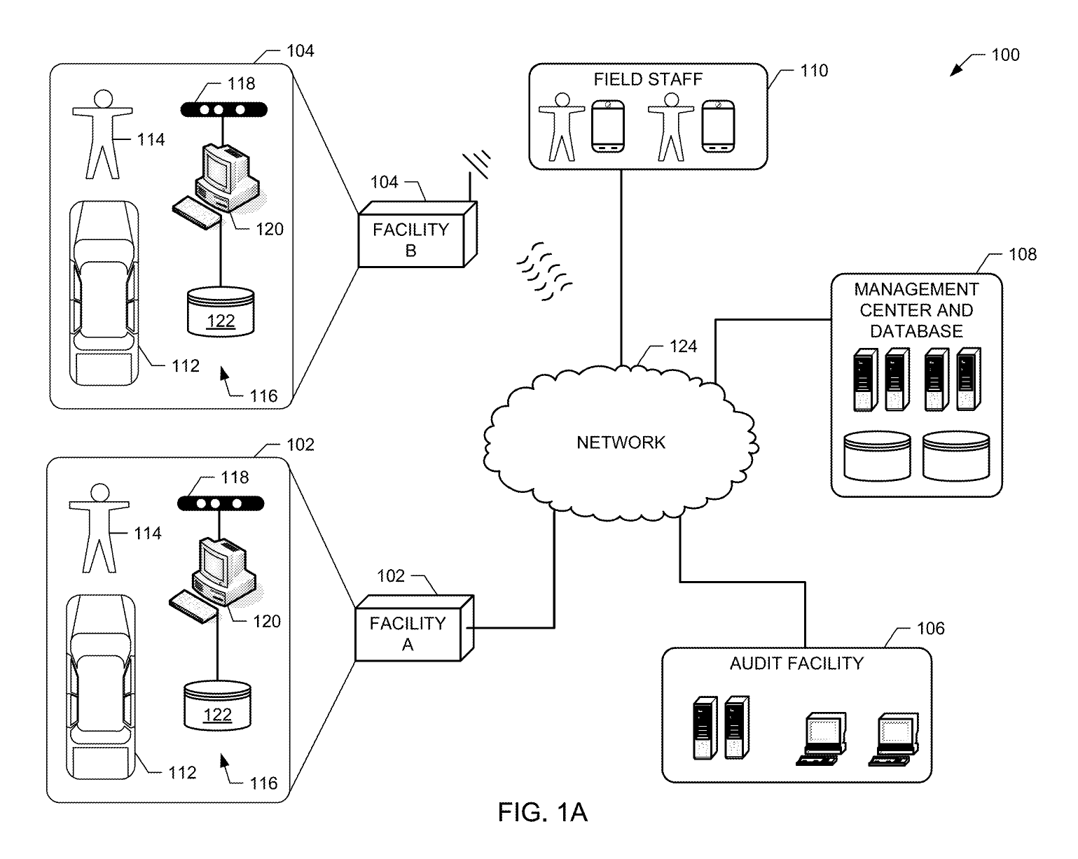

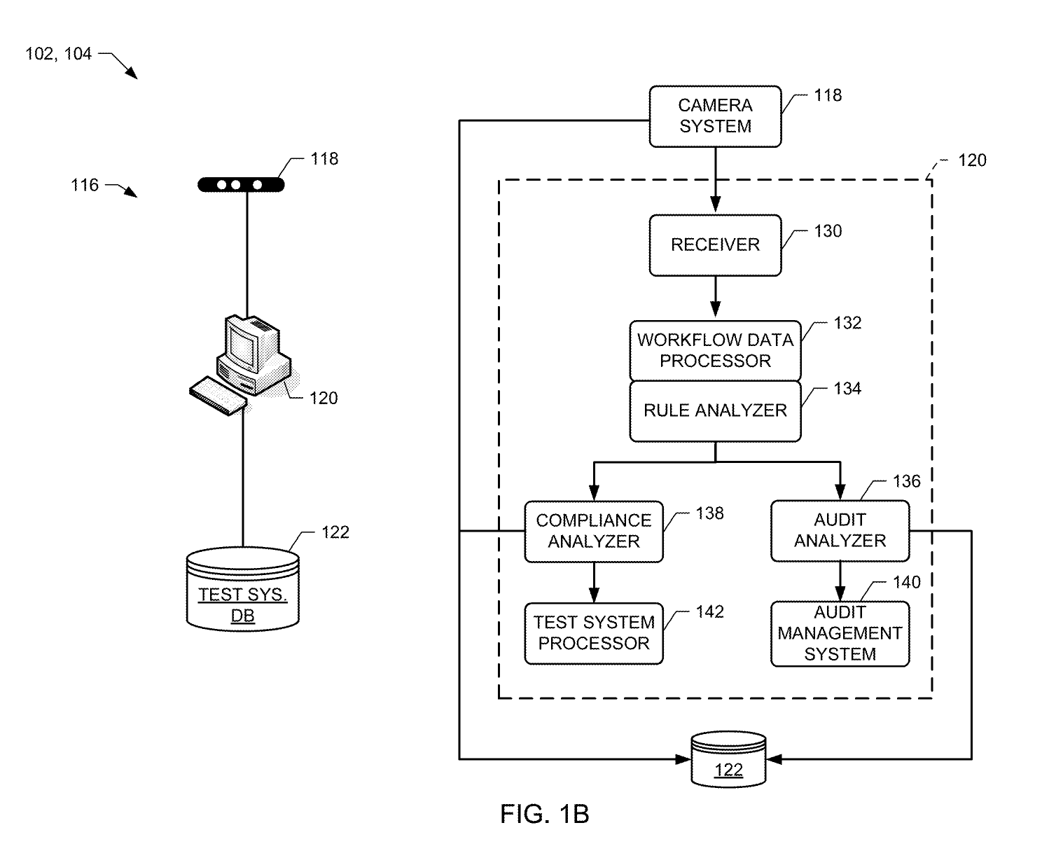

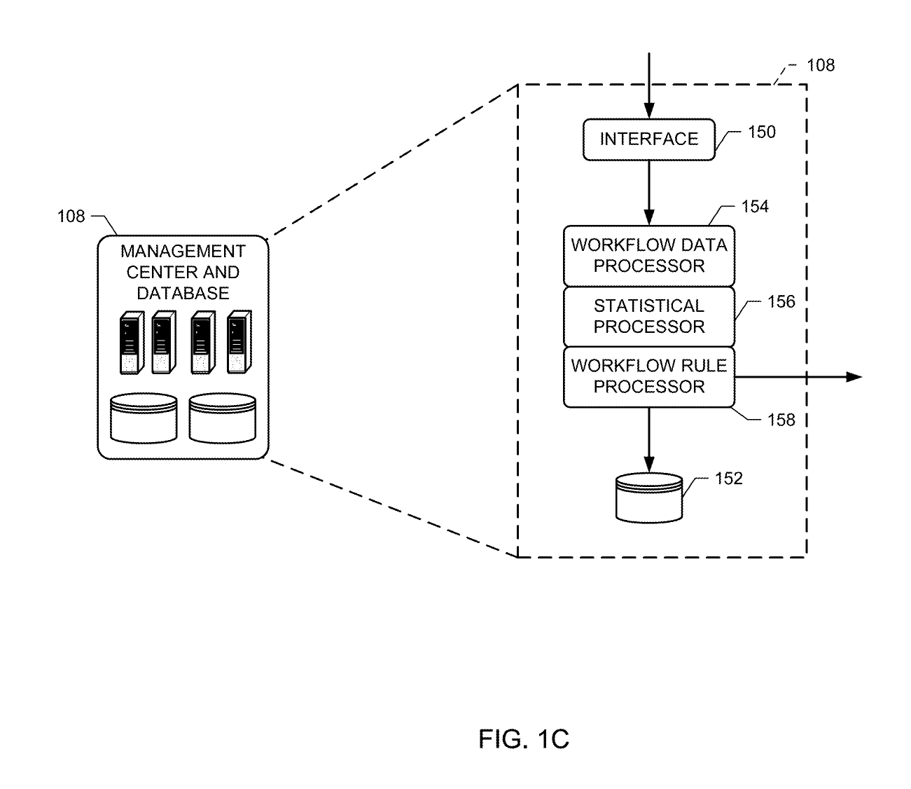

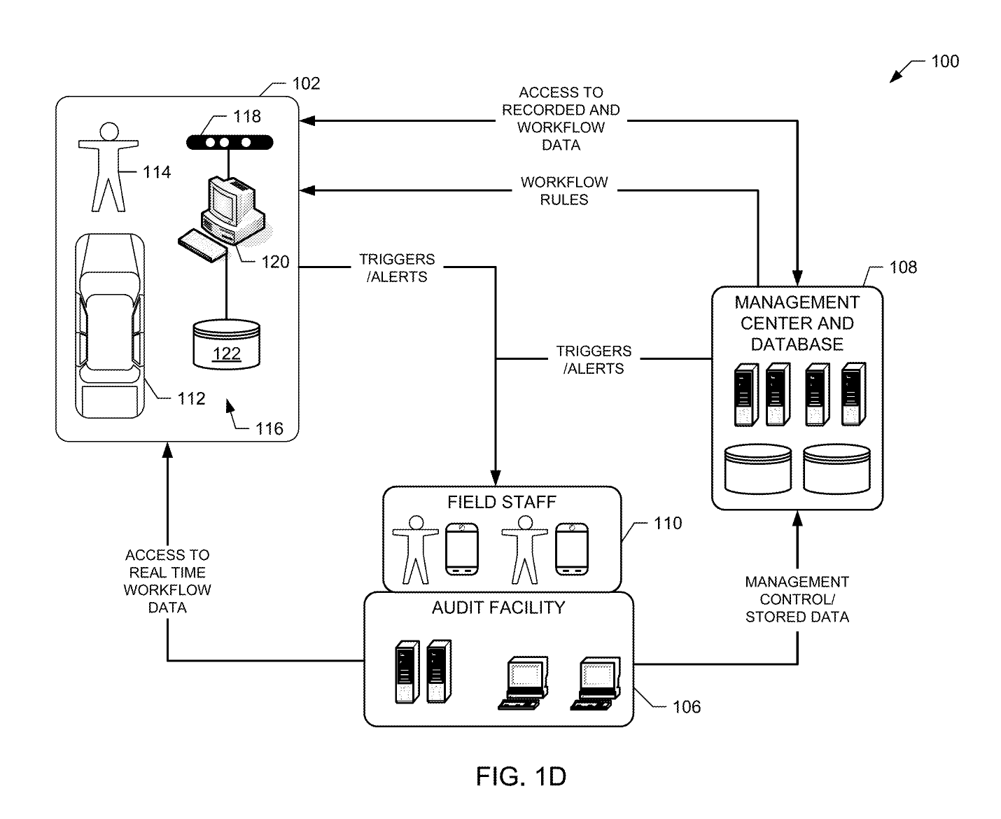

In the interest of brevity and clarity, throughout the following disclosure, reference will be made to an example inspection audit environment 100 of FIG. 1, which uses a single position inspection system. However, the methods, articles of manufacture, and apparatus described herein are applicable to other types of inspection facilities including, for example, multiple position systems. In these multiple position systems, the workflow auditing system may track an inspector between vehicle positions and/or track a vehicle between positions. Additionally, the methods, articles of manufacture, systems and apparatus described herein are applicable to other types of work environments, including, for example, manufacturing environments, process control environments, medical environments, service environments such as retail and restaurant environments and safety environments such as airports, etc. In the figures below, the present systems and methods are illustrated for example in connection with automobile emissions testing.

Vehicle Inspection Application

FIG. 1A shows a workflow auditing system 100 including inspection facilities 102 and 104, an audit facility 106, and a management center 108. The workflow auditing system 100 also includes field personnel 110 that interact with the facilities 102 to 108. The workflow auditing system 100 shows an example for implementing inspection quality control, compliance, and/or auditing. In other examples, the system 100 may include additional auditing facilities, inspection facilities, and/or management centers.

The inspection facilities 102 and 104 of the illustrated example include any dedicated inspection facility and/or any repair shop, garage, etc. that is licensed by a jurisdiction to perform inspections. The example facilities 102 and 104 can be located physically within one or more governmental jurisdiction to perform vehicle inspections. In examples in which the inspection facilities 102 and 104 are located in multiple jurisdictions, the audit facility 106 may monitor each inspector based on the standards for that inspector's particular jurisdiction.

In the illustrated example, the inspection facilities 102 and 104 perform vehicle inspections on passenger vehicles, taxies, buses, and/or commercial grade vehicles (e.g., vehicles 112). The example audit facility 106 applies the inspection standards for the type of vehicle when monitoring inspectors 114. For example, an inspection of a taxi may have different safety tests compared to an inspection for a passenger class motorcycle. In other examples, the facilities 102 and 104 may additionally or alternatively inspect airplanes, boats, recreational vehicles, etc. It is expressly contemplated that test equipment 114 included within the facilities 102 and 104 identifies a vehicle's size and shape to determine a type of inspection to perform. It is also expressly contemplated to identify a vehicle's make, model and/or color to verify that the vehicle matches a vehicle identification number (“VIN”) registered to the particular owner. It is further expressly contemplated to access previous vehicle inspection data by identifying vehicle's make, model, color, and/or VIN.

The example test equipment 116 of the facilities 102 and 104 includes a camera system 118, a test system controller 120, and a test system database 122. In other embodiments, the test equipment 116 can include other components or devices that are used to perform inspections. The example camera system 118 can include, for example, one or more cameras (still or video), depth sensors, color sensors, microphones, motion sensors, and/or any other component that is capable of detecting and recording environmental characteristics. The camera system 118 is configured to record data of actions performed by inspectors in relation to vehicles and inspection equipment.

The test system controller 120 is configured to process the recorded data into workflow data and compare the workflow data to predetermined workflow rules. The test system controller 120 is also configured to manage how inspectors perform an inspection. For instance, the test system controller 120 may select an inspection to perform upon receiving identifying characteristics of the vehicle 112. The test system controller 120 then prompts inspector 114 to perform procedures of the selected inspection in a designed sequence. The test system controller 120 uses workflow data to determine whether the inspector 114 successfully completed the procedure. In instances where a procured was not completed, the test system controller 120 stores a record of the deviation and/or transmits an indication of the deviation to, for example, the audit facility 106. The test system controller 120 may also prevent the inspector 114 from performing a next procedure until the current procedure is successfully completed.

As shown in FIG. 1A, the test system controller 120 includes a personal computer. In other embodiments, the test system controller 120 can include a workstation, laptop, server, a processor, a smartphone, a tablet computer, a personal digital assistant, etc. Further, while the test equipment 116 shows a single test system controller 120 for each facility 102 and 104, in some embodiments the functionality of the controller 120 may be partitioned among multiple processors. For instance, a server may collect, compile and process data while inspector 114 uses a tablet computer in wireless communication with the server as an interface to view, enter data, and provide feedback for inspection procedures.

The example test system database 122 stores data structures of inspections performed by inspectors 114. The data structures can include workflow data processed by the test system controller 120 and/or data recorded by the camera system 118. In some embodiments, the test system database 122 stores data structures of all procedures performed by inspectors 114. In other embodiments, the test system database 112 stores data structures of procedures that deviate or fail to satisfy a workflow rule. For instance, upon determining that a procedure was incorrectly performed by inspector 114, the test system controller 120 may store a data structure identifying the violated procedure, the corresponding workflow data used to determine the procedure was violated, and/or the data recorded by the camera system 118 used to generate the workflow data. In addition, the test system database 122 can store vehicle inspection data and/or workflow rules specified by, for example, the management center 108. The example database 122 may be implemented by Electronically Erasable Programmable Read-Only Memory (“EEPROM”), Random Access Memory (“RAM”), Read-Only Memory (“ROM”), and/or any other type of memory.

The example inspection facilities 102 and 104 are communicatively coupled to the audit facility 106 and the management center 108 via network 124. The network 124 can include, for example the Internet or some other data network, including, but not limited to, any suitable wide area network or local area network. The network 124 can connect the facilities 102 to 108 via a wired and/or wireless communication medium.

In some embodiments, the inspection facilities 102 and 104 transmit workflow data to the audit facility 106 and/or the management center 108 periodically (e.g., hourly, daily, weekly, etc.). In other examples, the inspection facilities 102 and 104 stream workflow data and/or transmit the workflow data upon processing the data. In yet other examples, the audit facility 106 and/or the management center 108 may request the workflow data as needed from each of the inspection facilities 102 and 104.

The example audit facility 106 of FIG. 1 monitors inspectors 114 of the facilities 102 and 104. The audit facility 106 receives workflow data from the facilities 102 and 104, processes the workflow data, and performs statistical analysis on the processed data to determine, for example, if inspectors 114 are performing inspection procedures within a specified deviation of a distribution of acceptable inspection data points. The acceptable data points can be established via a protocol that is established over time after monitoring multiple successfully completed inspections. The audit facility 106 may also generate flags to field personnel 110 that indicate a particular inspector and/or inspection facility should be audited.

The example audit facility 106 operates in conjunction with field personnel 110 (e.g., auditors) to periodically review workflow data based on indications of deviations from the test system controllers 120 and/or complaints received from customers. The field personnel 110 may also physically audit the inspection facilities 102 and 104 after receiving an indication from the test system controllers 120 or the audit facility 106. Additionally, processors, servers, and workstations at the audit facility 106 can filter through hours of inspector workflow data to highlight for field personnel 110 problematic and/or substandard inspector and/or inspection facilities.

The example management center 108 of FIG. 1A includes servers and databases configured to create workflow rules based on workflow data received from numerous facilities including the facilities 102 and 104. For instance, the management center 108 may receive one-thousand data structures of workflow data corresponding to an inspection procedure performed by different inspectors and/or inspection facilities. The management center 108 uses analytics, trend modeling, and statistical models of the compiled workflow data in conjunction with defined regulatory specification limits, common know-how, and/or best practices to determine workflow limits for a workflow rule. The management center 108 may also use this information to determine standard deviations from the workflow limits and other criteria for determining which workflow data corresponds to passing a workflow rule. The management center 108 may update or revise the workflow rules periodically as additional workflow data is compiled.

The management center 108 may also individualize workflow rules for each facility 102 and 104 based on unique characteristics associated with the facilities. These characteristics can include layouts of inspection areas, jurisdictional requirements, lighting and/or sound properties of the inspection areas, etc. The management center 108 can also individualize workflow rules for each inspector based on characteristics of the inspector (e.g., height, arm span, etc.).

In some embodiments, the management center 108 performs some of the processing described in conjunction with the test system controllers 120. For instance, the management center 108 may process data recorded from camera systems 118 into workflow data. The management center 108 may then locally compare the workflow data to workflow rules and transmit indications to the test system controllers 120 based on results of the comparison (e.g., prevent inspectors from performing a subsequent procedure/inspection).

The example management center 108 may also process workflow data in conjunction with the audit facility 106. For instance, the management center 108 may process workflow data from facilities 102 and 104 to determine when procedures deviate from a statistical distribution for one or more workflow rules. Alternatively, the management center 108 may store a count of indications of inspectors failing to successfully perform an inspection procedure. The management center 108 may then transmit messages to the audit facility 106 specifying which inspectors and/or inspection facilities have a number of deviations that exceed an allowed or predetermined amount.

While the management center 108 is shown as including servers and databases in a centralized location, in other embodiments the management center 108 can include distributed servers and/or databases. For instance, management centers 108 may be located regionally, located in each jurisdiction, and/or distributed in a cloud network. In further embodiments, the management center 108 may be combined with the audit facility 106.

FIG. 1B shows a functional block diagram of the test equipment 116 of the inspection facilities 102 and 104 of FIG. 1A. In this embodiment, the camera system 118 records actions of inspectors during an inspection. As mentioned before, the camera system 118 can include one or more video camera, still camera, infrared camera, heat camera, motion camera, proximity sensor, depth sensor, RFID sensor, microphone, thermometer, carbon monoxide sensor, etc. The camera system 118 transmits the recorded data to a receiver 130 of the test system controller 120.

The example receiver 130 is configured to receive recorded data from the camera system 118. The recorded data includes video recorded from cameras, audio recorded via microphones, and/or depth data sensed from depth sensors. The recorded data may also include any RFID and/or image recognition data recorded and/or detected by other types of sensors and/or cameras within the inspection facilities 102 and 104. The recorded data may also include identification data that identifies an operator, an inspection facility, an inspection test, a time, a day, a vehicle type, etc. While the inspector is typically personnel designated for perform vehicle inspections, “inspector” as used herein can be, but is not limited to, an operator, manufacturing person, service person, medical person, delivery person, office person, or any person performing a task in any type of industrial setting.

In some examples, the receiver 130 parses the recorded data into visual data, audio data, depth data, and/or identifying data. In these examples, the receiver 130 transmits each type of data to a workflow data processor 132 for analysis. The receiver 130 may also separate the recorded data into individual data frames for processing.

The example receiver 130 queues the received data for the example a workflow data processor 132. In some examples, the receiver 130 may hold the recorded data for an entire inspection of a vehicle prior to transmitting the data to the processor 132. In other examples, the receiver 130 may compile recorded data for an inspection test. Alternatively, the receiver 130 may transmit (e.g., stream) the recorded data to the processor 132 and/or the test system database 122.

The example workflow data processor 132 of FIG. 1B identifies actions performed by an inspector. To determine positions of objects in an image (e.g., recorded video), the example workflow data processor 132 uses depth data collected by depth sensor(s) to construct a three-dimensional model of the image. In alternative examples, the workflow data processor 132 may construct a two-dimensional object image using colors to represent depth and/or relative distances.

In the example of FIG. 1B, the workflow data processor 132 analyzes grid lines of depth data to determine distances. For example, a projector at the facility 102 and 104 may transmit a matrix grid pattern to a display area at the facility 102 and 104 (e.g., an inspection area and/or inspection position). A depth sensor at the facility 102 and 104 records the grid pattern reflecting off of objects in the display area. The grid pattern becomes distorted as the light reflects off of objects at different distances from the projector. The depth sensor detects the reflected grid pattern and transmits the recorded reflected grid pattern for processing by the workflow data processor 132.

In some examples, the workflow data processor 132 is calibrated to determine distances based on distances between grid pattern lines. In these examples, the workflow data processor 132 can determine, for example, that objects reflecting a grid pattern in which the grid lines are two centimeters (cm, about one inch) apart indicate that the objects are thirteen feet (3.96 meters) from the projector (e.g., the camera system 118). The workflow data processor 132 associates this determined distance data to the appropriate object within the image. Additionally, the workflow data processor 132 can count lateral and/or vertical grid lines to identify coordinates and/or physical locations of the objects in the display area. The workflow data processor 132 may also determine relative distances between each of the objects in the display area. For example, the workflow data processor 132 may determine that an operator is two feet (61 cm) from an edge of a vehicle.

In other examples, a depth sensor at camera system 118 may determine the distance information. For example, a depth sensor may be communicatively coupled to a processor, server, and/or workstation to determine absolute and/or relative distances. In other examples, the workflow data processor 132 determines the depth data as workflow data and may transmit this data to the audit facility 106 and/or the management center 108. In these alternative examples, the workflow data processor 132 receives the distance data and uses this data to construct the three-dimensional representation of the image.

After processing the depth data, the workflow data processor 132 of FIG. 1B creates a three-dimensional representation of the recorded video (e.g., an object image of workflow data) by identifying objects in an image. In some examples, the workflow data processor 132 identifies groups of pixels of an image that have similar depth data (e.g., a similar distance from the depth sensor). The workflow data processor 132 groups these pixels together as an object and compares the object to known objects (e.g., silhouettes of test equipment, vehicles, human body shapes). For example, the workflow data processor 132 may determine that an object is a vehicle, an operator, or test equipment.

In some examples, the workflow data processor 132 may identify objects based on other identifying information. For example, the workflow data processor 132 may identify a visual icon on an object that corresponds to an On-Board Diagnostic II (“OBDII”) connector. The visual icon could be a colored tag affixed to an object, a barcode affixed an object, and/or any other visual identifier than could be attached to an inspection tool and/or test equipment. In these instances, the workflow data processor 132 may analyze a visual image recorded by a camera to determine the identifying information for the workflow data.

In other instances, the workflow data processor 132 may use, for example, RFID data to determine which of the inspectors performed an inspection. In yet other instances, the workflow data processor 132 may use facial recognition technology to identify which inspector is in an inspection area. The workflow data processor 132 then uses the identity of the inspector to access identifying information (e.g., name, operator license number, etc.).

After identifying which object in recorded data is an inspector, the example workflow data processor 132 of FIG. 1B uses depth data to identify actions and motions of the inspector. To identify a motion for workflow data, the workflow data processor 132 may match an object to known motions of an inspector. These known motions can include, for example, walking, standing, bending over, sitting, squatting, reaching for an object, etc. In some examples, the workflow data processor 132 may identify joints of an inspector and partition the inspector into different body parts to compare different positions of body parts to a database of corresponding positions.

Once the objects and the motions of an inspector have been identified, the example workflow data processor 132 constructs a three-dimensional representation of an image for the workflow data by placing the objects at relative locations within a display area (e.g., inspection area). The workflow data processor 132 repeats these processes for each image and combines these images together into a set of images. The workflow data processor 132 may also overlay the objects upon a video image recorded by a camera. In other examples, the object image may be stored in parallel to video images. In these other example, the objects may be displayed in conjunction with a video image when requested by field staff 110.

In addition to processing video and/or depth data into workflow data, the example workflow data processor 132 may also process audio recorded by one or more microphones. In these examples, the workflow data processor 132 decodes and/or uses filters to identify voice commands from an inspector. Additionally, the workflow data processor 132 may uses filters to identify engine noise, horns, and/or any other noises that are relevant to conduct an inspection. The workflow data processor 132 may then associate a time space of the audio with corresponding video and/or object images.

To determine if actions performed by an inspector violate a workflow and/or are outside of a distribution of acceptable workflow limits of a workflow rule, the example test system controller 120 of FIG. 1B includes a rule analyzer 134. The example rule analyzer 134 receives workflow data including processed video, audio, and/or object data from the workflow data processor 132 and analyzes this data to determine if an inspector has improperly performed an inspection procedure. After receiving the workflow data, the rule analyzer 134 determines which procedure of an inspection an operator is performing. The rule analyzer 134 may determine a procedure based on information input by an inspector. In other examples, the rule analyzer 134 may identify a procedure based on tools used by an inspector and/or actions/functions performed by the inspector. For example, the rule analyze 134 determines from the workflow data than an inspector has opened a hood of a vehicle. In response, the rule analyzer 134 determines that an engine inspection procedure is being performed. In further instances, when an inspection procedure is not readily ascertainable, the rule analyzer 134 may compare all the workflow rules for an inspection to all of the detected actions of an inspector to determine which procedures have not been completed.

The example rule analyzer 134 accesses a database (e.g., the test system database 122) for workflow rules. In this embodiment, the management center 108 transmits the workflow rules to the database 122. The workflow rules are specified by auditors, best practices, regulations, and/or jurisdictions based on acceptable functions, motions, and/or actions an inspector should perform to complete a test. In these examples, auditors may access and/or update the workflow rules through the audit facility 106 or the management center 108. For example, the workflow rules may be updated from time to time as system 100 ages and collects more and more data that better or more correctly delineates acceptable vehicle emissions testing from inadequate testing.

The workflow rules include workflow limits that indicate when spatial positioning, time, motions, actions, functions specified in workflow data exceed or fail to meet specified, predetermined thresholds. For example, a first workflow limit of a workflow rule specifies an area that an inspector is to move into to perform a procedure, a second workflow limit of the workflow rule defines an action that is to be performed by an inspector within the area, and a third workflow limit of a workflow rule specifies a minimum time that is needed to satisfactorily complete the action. In other examples, the workflow limits of workflow rules can specify functions that an inspector is to perform or motions that are characteristic with successfully completing an inspection procedure.

The workflow rules may be two-dimensional rules that specify specific areas within an inspection area. For example, a workflow rule may include limits that specify an inspector is to move into a hexagonal area that is positioned at a rear of a vehicle. In this example, the rule analyzer 134 uses the identification of the rear of a vehicle in a video image and/or three-dimensional object image of the workflow data and applies the workflow rule to the image. The rule analyzer 134 then applies the workflow rule to subsequent images to determine if an inspector has traveled into this area. In other examples, the workflow rules may be three-dimensional rules that can be integrated with a three-dimensional object image. An example three-dimensional workflow rule could require an inspector to not simply open a hood of the automobile, swinging through a two-dimensional arc, but also to swing a hood stand into place through a different two-dimensional arc, thereby requiring the rule analyzer 134 to analyze three dimensions of workflow data.

The rule analyzer 134 also applies time-based workflow rules to times to perform actions indicated in workflow data. In other words, the rule analyzer 134 can be configured to use time as a workflow rule. For instance, the rule analyzer 134 can determine whether an inspector remained in an area long enough to complete a thorough examination. Also regarding time, certain testing procedures may require that a sample be taken for at least a specified duration. An exhaust probe, for example, may be required to sample for a minimum duration. The rule analyzer 134 ensures that a sample has been taken over a specified minimum duration.

The rule analyzer 134 may also access the database 122 for distribution data for an inspection procedure. In these instances, the rule analyzer 134 may compare the workflow data of an inspector to a distribution of data points of previous inspections to determine if the current inspector actions are outside an acceptable deviation. The previous data points may be provided by the management center 108. In other instances, the data points may be created by the management center 108 based on a statistical analysis of acceptable actions to determine a range of acceptable actions within a specified deviation. The rule analyzer 134 may then perform statistical analysis on each object image in the workflow data to calculate an amount of time an inspector has been outside the distribution. The rule analyzer 134 then compares the calculated amount of time to determine if the inspector has been deviating from the distribution for a period of time that exceeds a predetermined threshold. In these examples, the audit facility 106 or the management center 108 may update and/or revise the statistical analysis.

After finding a deviation from a workflow rule and/or determining that an action of an inspector is outside of a distribution, the rule analyzer 134 of FIG. 1B generates a flag and/or an indication. Rule analyzer 134 transmits the flag to an audit analyzer 136, which notifies the audit facility 106 than an inspection deviation has occurred. The rule analyzer 134 also transmits an indication of the deviation to a compliance analyzer 138, which determines whether the inspector should re-perform the procedure.

Rule analyzer 134 may also store video, audio, identification information, image objects, and/or other workflow data to the database 122. In some instances, the rule analyzer 134 may store video, audio, identification information, and/or image objects associated with an entire inspection session of a vehicle. In other instances, the rule analyzer 134 may store video, audio, identification information, and/or image objects associated with a procedure of the inspection that generated the deviation. In alternative examples, the rule analyzer 134 may store all video, audio, identification information, and/or image objects regardless of whether a flag was generated.

The example audit analyzer 136 compiles a number of times that the inspection facilities 102 and 104 and/or inspectors 114 are flagged for a deviation of an inspection procedure. The example audit analyzer 136 receives indications of deviations from the rule analyzer 134. In some examples, the audit analyzer 136 may compile different types of inspection deviations in different categories (e.g., mild, severe, etc.) based on how much an inspector has deviated from a workflow rule and/or how many rules have gone unsatisfied. In these examples, the different categories may also correspond to an importance of an inspection procedure. For example, improperly inspecting a vehicle's brakes may trigger an audit for fewer violations than compared to violations for improperly inspecting a vehicle's windshield.

The audit facility 106 specifies deviation thresholds for the inspectors and/or the facilities 102 and 104. In some examples, the audit facility 106 may specify different thresholds for different inspection facilities 102 and 104 and/or inspectors based on known histories of violations. For example, a more problematic inspection facility may have a lower threshold.

The example audit analyzer 136 of the illustrated example determines if any inspectors and/or inspection facilities 102 and 104 have enough flags or deviations to trigger an audit. If a number of flags exceeds a threshold, the audit analyzer 136 may transmit an indication and/or a message to the audit facility 106 identifying the inspection facility and/or inspector and a number of associated flags or deviations.

The example audit analyzer 136 of FIG. 1B is communicatively coupled to an audit management system 140, which includes an interface to enable field personnel 110 or the audit facility 106 to view workflow data and/or results of inspections as reported by the rule analyzer 134. For instance, the audit management system 140 includes an interface that transits an indication of a deviation to a field quality control staff member 110. In response to receiving the indication, the staff member 110 can access the audit management system 140 to view in real-time workflow data. This enables the staff member 110 to monitor an inspection in progress that has already been flagged with a deviation. The staff member 110 can, for example, view video as processed by the workflow data processor 132 to monitor how the inspector is performing a flagged procedure and/or subsequent procedures.

The example audit management system 140 includes any application programmable interface (“API”) that the field personnel 110 or the audit facility 106 may access via a computer, workstation, smartphone, etc. The audit management system 140 enables auditors to view recorded inspections, rendered three-dimensional object images of inspections, overlays of object information with video image, and/or playbacks of recorded video and audio. The example audit management system 140 also enables auditors to view statistics regarding which inspectors and/or inspection facilities have been flagged for which inspection test deviations.

In some embodiments, the audit management system 140 may enable the staff member 110 to initiate a live-communication session (e.g., video meeting, instant message session, phone call, etc.) with an inspector flagged for a deviation to discuss the deviation. The audit management system 140 may also enable the audit facility 106 or the field staff 110 to monitor in real-time inspections being performed by an inspector under probation or by inspector of a facility 102 and 104 under probation without the rule analyzer 134 generating an indication of a deviation. The example audit management system 140 further enables the audit facility or the management center 108 to review stored workflow data for deviations from workflow rules and/or to refine workflow rules.

As briefly discussed above, the rule analyzer 134 of FIG. 1B transmits an indication of an inspection procedure deviation to the compliance analyzer 138 to determine how the inspection is to continue. The compliance analyzer 138 may use the indication to determine whether the severity of the indication warrants the procedure to be re-run by an inspector, warrants the inspection to be re-run, or whether the inspection can continue. For instance, the compliance analyzer 138 may also determine which procedure is associated with the deviation when processing whether to continue an inspection.

In an example, the compliance analyzer 138 receives an indication that an inspector failed a workflow rule corresponding to viewing a rear taillight of a vehicle. The compliance analyzer 138 receives from the rule analyzer 134 a distance the inspector was from the workflow limit. The compliance analyzer 138 may allow the inspection to continue of the deviation distance is relatively small (e.g., a few inches to a foot). In another example, the compliance analyzer 138 determines that an inspection procedure for measuring exhaust from a vehicle has to be re-preformed by an inspector because the inspector failed to maintain a sensor in the exhaust for a specified length of time specified by a workflow limit of a workflow rule.

To control an inspection test flow based on instructions from the compliance analyzer 138, the example test system controller 120 of FIG. 1B includes a test system processor 142. Test system processor 142 uses feedback from rule analyzer 134 and the compliance analyzer 138 to determine in real-time whether an inspector completed a procedure. In some alternative embodiments, the example test system processor 142 may be used in the centrally located management center 108.

The example test system processor 142 includes a test script that includes details and/or an order of inspection procedures. In this manner, the test system processor 142 performs a process control (e.g., quality control or quality assurance) function to ensure that an inspection is completed according to workflow rules and/or distributions. During an inspection, test system processor 142 receives from the rule analyzer 134 information regarding which test an inspector is performing. In other instances, an inspector can provide the test system processor 142 with the test being performed. The test system processor 142 then determines if the inspector has successfully completed the test by communicating with the rule analyzer 134 and/or the compliance analyzer 138 to determine if an indication of a deviation was generated. If a deviation is not generated, and/or the rule analyzer 134 indicates the inspector has satisfied a workflow rule and/or is within a distribution, the test system processor 142 processes the procedure as being completed. The test system processor 142 then enables an inspector to begin the next inspection procedure.

However, if the compliance analyzer 138 provides an instruction that a current procedure deviation cannot be disregarded, the example test system processor 142 prevents the inspector from beginning the next inspection procedure until the current procedure has been completed. In some instances, the test system processor 142 may provide a prompt and/or message to the inspector communicating how the procedure is to be performed. In other examples, the test system processor 142 may transmit a visual representation of a workflow rule displayed with a visual image of the inspection area to show the inspector where to move or how to function to complete the procedure. In any event, system 100 is used here for process control in addition to and/or alterative to process monitoring and/or auditing.

In some instances, test system processor 142 may not be configured to prevent an inspector from beginning a next inspection procedure. In these instances, the test system processor 142 may record in a test result that an inspector failed to perform a procedure or test as defined by a workflow rule and/or distribution. Additionally or alternatively, the test system processor 142 may send an indication to audit analyzer 136 regarding the incomplete and/or improper inspection.

In an example if FIG. 1B, the camera system 118 records video, depth data, and audio of an inspector performing an inspection test. The workflow data processor 132 processes the recorded data into workflow data including multi-dimensional video data, time-based data, motion characteristics data, functional data, and/or action data. The rule analyzer 134 uses the workflow data to identify the inspector, the vehicle under inspection, and the inspection procedure being performed. The rule analyzer 134 then compares limits of a workflow rule corresponding to the procedure to the workflow data. The rule analyzer 134 reports any deviations to the audit analyzer 136 and/or the compliance analyzer 138. The rule analyzer 134 also reports the result of the comparison to the test system processor 142, which then determines if the inspector can perform the next inspection procedure.

While the example test equipment 116 and/or the test system controller 120 has been illustrated in FIG. 1B, one or more of the servers, platforms, interfaces, data structures, elements, processes and/or devices illustrated in FIG. 1B may be combined, divided, re-arranged, omitted, eliminated and/or implemented in any way. Further, the example receiver 130, the example workflow data processor 132, the example rule analyzer 134, the example audit analyzer 136, the example compliance analyzer 138, the example audit management system 140, the example test system processor 142, and/or more generally, the example test system controller 120 may be implemented by hardware, software, firmware and/or any combination of hardware, software and/or firmware. Thus, for example, any of the example receiver 130, the example workflow data processor 132, the example rule analyzer 134, the example audit analyzer 136, the example compliance analyzer 138, the example audit management system 140, the example test system processor 142 and/or more generally, the example test system controller 120 could be implemented by one or more circuit(s), programmable processor(s), application specific integrated circuit(s) (“ASIC(s)”), programmable logic device(s) (“PLD(s)”) and/or field programmable logic device(s) (“FPLD(s)”), etc.

When any apparatus claim of this patent is read to cover a purely software and/or firmware implementation, at least one of the example receiver 130, the example workflow data processor 132, the example rule analyzer 134, the example audit analyzer 136, the example compliance analyzer 138, the example audit management system 140, and/or the example test system processor 142 are hereby expressly defined to include a computer readable medium such as a memory, DVD, CD, etc. storing the software and/or firmware. Further still, the example test system controller 120 may include one or more elements, processes and/or devices in addition to, or instead of, those illustrated in FIG. 1B, and/or may include more than one of any or all of the illustrated elements, processes and devices.

FIG. 1C shows a functional diagram of the example management center 108 of FIG. 1A. The example management center 108 determines workflow limits for workflow rules based on, for example, statistical distributions of workflow data, regulatory specification limits, common know-how, and best practices. The example management center 108 may also process workflow data to identify deviations of workflow rules.

The example management center 108 includes an interface 150 to receive recorded data and/or workflow data from facilities (e.g., facilities 102 and 104). The interface 150 may also include any type of web-based interface for receiving and/or requesting workflow data and/or recorded data from inspection facilities. The example interface 150 holds workflow data and recorded data until processors are available. The example interface 150 may also store or archive recorded and workflow data to a database 152. In some embodiments the interface 150 receives steams of workflow data and recorded data as the data is generated. In other embodiments, the interface 150 receives workflow data and/or recorded data at periodic times (e.g., daily).

To process the recorded and workflow data, the management center 108 includes a workflow data processor 154, a statistical processor, 156, and a workflow rule processor 158. The processors 154 to 158 determine workflow limits based on workflow data and/or recorded data. The processors 154 and 158 may adjust workflow rules for different inspection facilities and/or inspectors. The processors 154 and 158 also may determine thresholds for triggering audits and/or compliance rules for determining when an inspection procedure should be repeated.

The example workflow data processor 154 is similar to the workflow data processor 132 of FIG. 1B. In the management center 108, the workflow data processor 154 processes raw recorded data into workflow data in instances when the facilities 102 and 104 transmit unprocessed recorded data. The workflow data processor 156 transmits this data to the statistical processor 156 for analysis. In instances where the data is already processed into workflow data, the interface 150 transmits the data directly to the statistical processor 156.

The statistical processor 156 applies algorithms, routines, functions, etc., to compile workflow data to determine workflow limits for workflow rules. The statistical processor 156 also refines workflow rules as additional data becomes available. For instance, the statistical processor 156 accesses from, for example, the database 152 all workflow data associated with a particular procedure. The statistical processor 156 then identifies workflow limits (e.g., time, motion, functions, actions, etc.) that comprise the workflow rule. For each limit, the statistical processor 156 calculates a distribution of the workflow population data. The statistical processor 156 then compares the distribution to specification limits, best practices, common know-how to determine what percentage of the distribution is passing. The statistical processor 156 then sets a limit so as to comply with regulatory limits, be consistent with common know-how and best practices, and fails only a relatively small portion of the distribution. In instances where there are conflicting goals, the statistical processor 156 sets the limits to comply with regulatory limits first. Upon determining limits for a workflow rule, the statistical processor stores the limits to database 152.

The example workflow rule processor 158 of FIG. 1C modifies workflow rules based on individual characteristics of an inspection facility, an inspection area, and/or an inspector. For example, the workflow rule processor 158 may modify workflow rules and/or limits to accommodate different layouts of inspection positions and/or inspection facilities 102 and 106. In these examples, the workflow data processor 154 compiles audio, video, and/or depth data (e.g., workflow data) for an inspector and/or inspection area. The workflow rule processor 158 then modifies a workflow rule based on an individual distribution of workflow data specific for an instructor and/or an inspection area to satisfy an inspection procedure. For instance, the workflow rule processor 158 may determine that inspection facility 102 is generating too many false-positive results for a brake inspection procedure. The workflow rule processor 158 may update the workflow rules and/or limits based on an analysis so that a majority (e.g., 80%, 95%, etc.) of the inspectors would successfully complete the inspection procedure at the facility 102.

As shown in FIG. 1C, the workflow rule processor 158 also transmits workflow rules to facilities. In addition, the workflow rule processor 158 provides the test system controllers 120 with thresholds for triggering audits, compliance rules for continuing inspection procedures, and/or triggers for sending notifications to the audit facility 106. Further, the management center 108 may use the workflow rule processor 158 to perform other maintenance and upkeep of the data stored at the test system databases 122 (e.g., current inspection procedures).

FIG. 1D is a diagram of information flow between inspection facility 102, the audit facility 106, the management center 108, and the field personnel 110, as described in conjunction with FIGS. 1A to 1C. This figure shows one way in which information can be transmitted. One can appreciate that as different facilities or processing components are rearranged, the flow of information will accordingly change.

As described, the management center 108 provides the facilities with workflow rules and receives from the facilities recorded and workflow data. The management center 108 also transmits alerts and/or triggers to the audit facility 106 and/or field personnel 110 responsive to analyzing recorded and/or workflow data. The management center 108 further provides the audit facility 106 and/or the field personnel 110 access to management control of workflow rules or audit thresholds and/or to archived recorded/workflow data.

Additionally, the facility 102 transmits triggers and/or alerts to the audit facility 106 and/or the field personnel 110 in response to an inspector failing to satisfactorily perform inspection procedure and/or an inspector/inspection facility accumulating enough deviations to exceed a threshold. The facility 102 also makes available to the audit facility 106 and/or the field staff 110 recorded data, workflow data, and/or any other real time data. The audit facility 106 and/or the field staff 110 may also connect to the facility 102 to monitor or interface with inspectors.

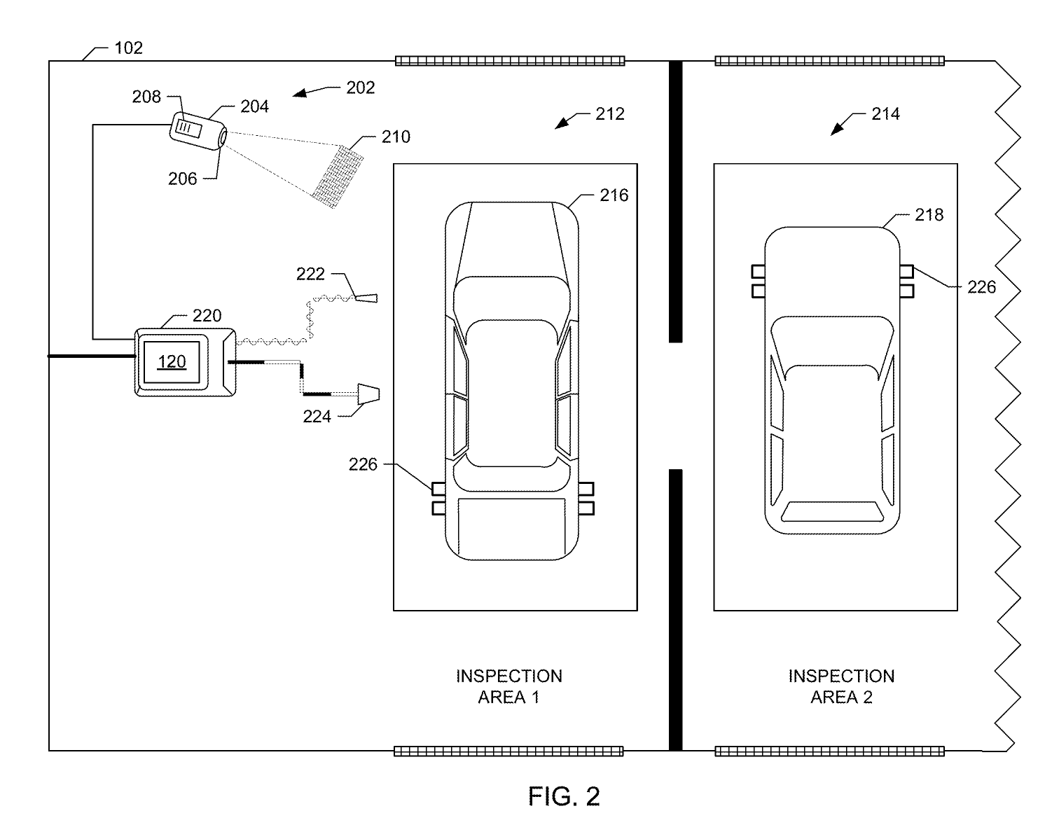

FIGS. 2 to 4 show a plan view of the inspection facility 102 of FIG. 1 including a camera system 202 (similar to camera system 118). The example camera system 202 includes a video camera 204, a projector 206 and a depth sensor 208. In other examples, the camera system 202 can include any one or more of a microphone, a facial recognition camera, and an RFID sensor, etc.

Video camera 204 includes any type of camera for recording video. Projector 206 includes any type of projector for transmitting a grid pattern to determine distances of objects from the camera system 202. In this example, the projector 206 transmits a rectangular matrix grid pattern 210. In other examples, the projector 206 can transmit differently shaped grid patterns. For clarity, the grid pattern 210 is shown not reflecting off of objects within the inspection facility 102.

To detect the reflected grid pattern 210, the example camera system 202 includes the depth sensor 208. The example depth sensor 208 records reflected light from the grid pattern 210 and transmits this recorded depth data to the test system controller 120 of FIG. 2 or FIG. 1A. For example, the depth sensor 208 may process the received light to calculate distances to objects. In these examples, the depth sensor 208 is calibrated to determine a distance based on a distance between a spacing of the lines in the reflected grid pattern 210. For example, a relatively large distance between grid lines indicates that an object is relatively far away. The example depth sensor 210 may also determine a spatial positioning of an object within the grid pattern 210 to determine relative distances between the objects.

The example inspection facility 102 of FIG. 2 also includes inspection areas 212 and 214. The inspection areas 212 and 214 are sections of the facility 102 in which inspector(s) perform vehicle safety and/or emission inspections. Inspection procedures performed by the inspection facility 102 include, for example, vehicle identification tests, brake tests, exhaust tests and analysis (e.g., blue smoke tests), steering and suspension tests, horn tests, windshield and window tests (e.g., windshield wiper and washer tests), mirror tests, lighting tests, tire inspections, bumper inspections, fuel tank inspections, body/frame inspections, seat belt tests, airbag tests, fuel cap tests, etc.

The inspection area 212 accepts vehicle 216, while inspection area 214 accepts vehicle 218. In this example, the inspection facility 102 provides single position inspections. In other words, an entire vehicle inspection of, for example, the vehicle 216 is performed in the inspection area 212.

The inspection area 212 is associated with an inspection terminal 220, which includes the test system controller 120. Similarly, the inspection area 214 is associated with a separate inspection terminal (not shown). An operator interfaces with the inspection terminal 220 to, for example, provide information about the vehicle 216, provide results of inspection tests, and/or read directions regarding an inspection test. The example inspection terminal 220 includes any type of computer, workstation, processor, server, etc., and operates any type of inspection application(s).

The inspection terminal 220 of FIG. 1 is communicatively coupled to the audit facility 106 and/or the management center 108 via any wired and/or wireless communication medium. The test system controller 120 of FIG. 2 may provide real-time process control inspection monitoring by preventing inspectors from beginning an inspection procedure if a previous procedure was not properly completed. The test system controller 120 processes video, audio, and/or depth data recorded by the camera system 202 into workflow data for audit reviews. In other examples, the inspection terminal 220 may not include all of the components of the test system controller 120 described in conjunction with FIG. 1B. In these examples, entered data is processed by the appropriate components in a remotely located server.

Inspection terminal 220 also includes tools used by an inspector to perform an inspection. In this example, the tools include a scanning tool 222 and an analysis probe 224. In other examples, the tools can include additional and/or different types of tools than those described herein. In this example, the scanning tool 222 reads a vehicle identification number (“VIN”) and the analysis tool 224 communicatively couples to a communication system of the vehicle 216, such as via a computer link, e.g., a Universal Service Bus (“USB”), link to the vehicle's computing system, to read diagnostic information, trouble codes, engine emission statistics calculated by an engine controller, and/or any other types of information that the vehicle 216 may store.

The inspection terminal 220 is also provided with a microphone 228 in one embodiment. Microphone 228 can be used to detect noises, such as engine noises, e.g., for testing purposes. Microphone 228 can alternatively or additionally be used to control the inspection, e.g., via voice command from the operator or via a sound command (sonic, subsonic or ultrasonic), e.g., via a handheld control device operated by the operator. Signals received by microphone 228 are analyzed using the processing of video auditing and/or control system 110a as discussed in detail herein.

For example, the test system controller 120 of FIG. 2 can be configured to compare an aspect of a sound detected by the microphone 228 to a like aspect of a stored sound. For instance, the test system database 122 may store an aspect of sound corresponding to an engine starting, an engine stopping, a horn, or a trunk closing. The test system controller 120 compares workflow data including aspects of the received sound to the stored aspects of the corresponding sound in a workflow rule to determine if the inspector adequately performed an inspection procedure.

Alternatively, the test system controller 120 may detect the presence of sound in workflow data to determine whether an inspection procedure was adequately performed. For instance, an inspection procedure may specify that an inspector is to open a hood to check an engine. The test system controller 120 determines that the inspector opened the hood upon identifying the sound of the hood being opened in the recorded data or the workflow data.

The example inspection areas 212 and 214 of FIG. 2 may also include tools and/or devices for inspecting the vehicles 216 and 218. In the illustrated example, inspection areas 212 and 214 include dynamometers 226 for testing torque and/or a drivetrain of the vehicles 216 and 218. In other examples, the inspection areas 212 and 214 include other tools and/or devices such as, for example, exhaust meters, engine noise sensors, and/or headlight sensors.

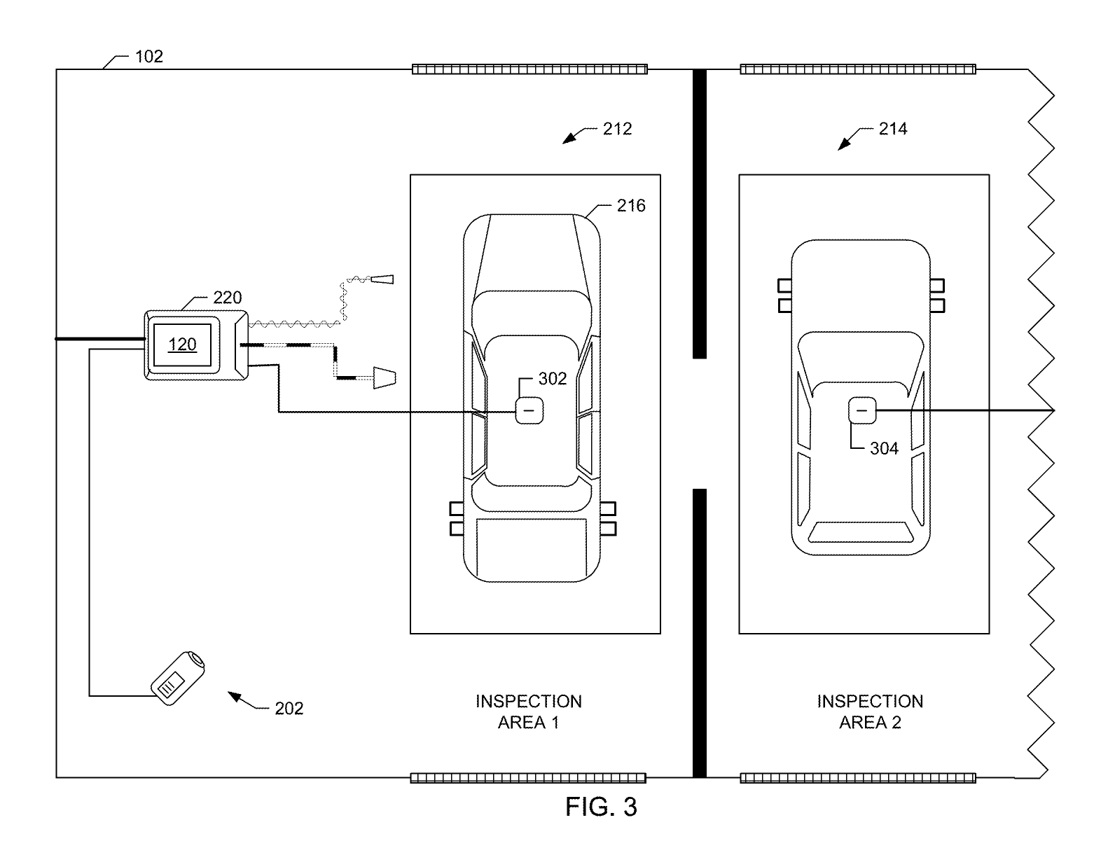

FIG. 3 shows an example inspection station 102, which includes additional camera systems 302 and 304. In this example, the camera systems 202 and 302 record audio, video, and/or depth data for inspection area 212. Additionally, camera system 304 provides a second perspective for the inspection area 214. In other examples, each of the inspection areas 212 and 214 can include additional camera systems.

Second camera system 302 provides a second perspective, which the test system controller 120 can use to construct a three-dimensional representation and/or rendering of the inspection area 212. For example, camera system 202 may not be able to accurately record inspector actions at a right-front portion of the vehicle 216 because the vehicle 216 blocks a clear view of that area. Second camera system 302 solves this issue by providing a second perspective. In some examples, extra camera systems 302 and 304 may only record video, while the camera system 202 records video, audio, and/or depth data. While the camera systems 302 and 304 are shown as being wired to the respective inspection terminals 220, the camera systems 302 and 304 may be wirelessly coupled to the single inspection terminal 220.

FIG. 3 also illustrates that example test system controller 120 concurrently receives recorded video, audio, and/or depth data recorded by the camera systems 202 and 302 to construct at least one three-dimensional object image (e.g., workflow data). In these examples, the test system controller 120 may include different workflow rules and/or statistical distribution of workflow limits corresponding to an allowed range of action or motion for each perspective of the camera systems 202 and 302. The example test system controller 120 stores the two video and/or audio steams so that an auditor can view the two different perspectives when reviewing an inspector.

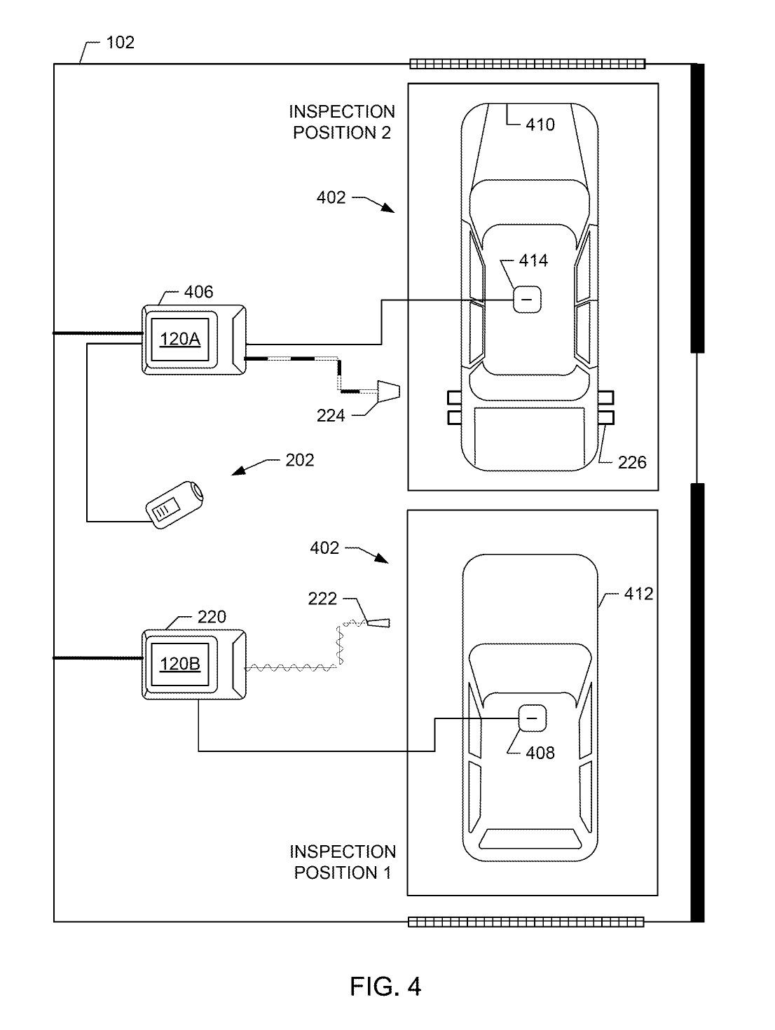

FIG. 4 shows the example inspection facility 102 configured as a multi-position inspection system. In this example system, the inspection facility 102 has a first inspection position 402 and a second inspection position 404. The first inspection position 402 is associated with the inspection terminal 220, which includes test system controller 120A. The second inspection position 404 is associated with the inspection terminal 406, which includes test system controller 120B. In other examples, the inspection facility 102 can include three or more vehicle positions.

In the example of FIG. 4, inspection terminal 220 includes scanner 222 and camera system 408. The camera system 408 records actions of an inspector within the first inspection area 402. At this first inspection area 402, an inspector performs a first portion of an overall inspection using the scanner 222 and/or any other needed tool. In this example, a vehicle 410 starts an inspection at the first inspection position 402. After performing the first portion of the inspection, the vehicle 410 is moved to the second inspection position 404, where an inspector (same or different) uses an analysis probe 224 and a dynamometer 226 to inspect vehicle 410. When vehicle 410 is moved to the second inspection position 404, another vehicle 412 is moved into the first inspection area 402 to begin an inspection.

In the illustrated example, the camera system 202 monitors both of the inspection positions 402 and 404 in conjunction with overhead camera systems 408 and 414, respectively. In particular, test system controller 120A monitors the first inspection position 402 using the camera systems 202 and 408, while test system controller 120B monitors the second inspection position 404 using the camera system 202 again, but here in combination with overhead camera 414. The camera system 202 may be controllable by the test system controllers 120A and 120B to follow a particular vehicle and/or inspector. For example, if the test system controller 120A detects that an inspector has failed to properly perform an inspection procedure at the first inspection position 402, the test system controller 120A can send an instruction to the test system controller 120B to begin tracking the inspector with the camera system 202 when the inspector moves into the second inspection position 404.

In any case, controllers 120A and 120B can share camera 202, which can be rotated via a motor, such as a positionable stepper motor under the control of one of the controllers 120A and 120B or a server that coordinates both systems. Alternatively, a separate side-looking camera system, such as station 202 is provided for each inspection position 402 and 404. Still further alternatively, a camera system 202, is provided on both sides of vehicle 410, located between positions 402 and 404. Here, stations 202 can both be motorized so that both sides of vehicle 410 can be monitored in both positions 402 and 404 and also when moving between the positions.

The example test system controller 120A and 120B coordinate recorded data so that video, audio, and/or depth data for an entire inspection is available as a single session despite the vehicle being in the multiple inspection positions 402 and 404. In some examples, the test system controller 120A may transmit the inspection data to the test system controller 120B when, for example, the vehicle 410 moves to the second inspection position 404. In these examples, the inspection terminal 220 may also transmit test information to the inspection terminal 406 to compile a complete inspection record. In other examples, the test system controller 120A and 120B may be included within a test system controller central to the inspection facility 102. In yet other instances, the test system controller 120 of FIGS. 1A and 1B may combine the data transmitted by each of the test system controller 120A and 120B to form a complete record of a vehicle inspection.

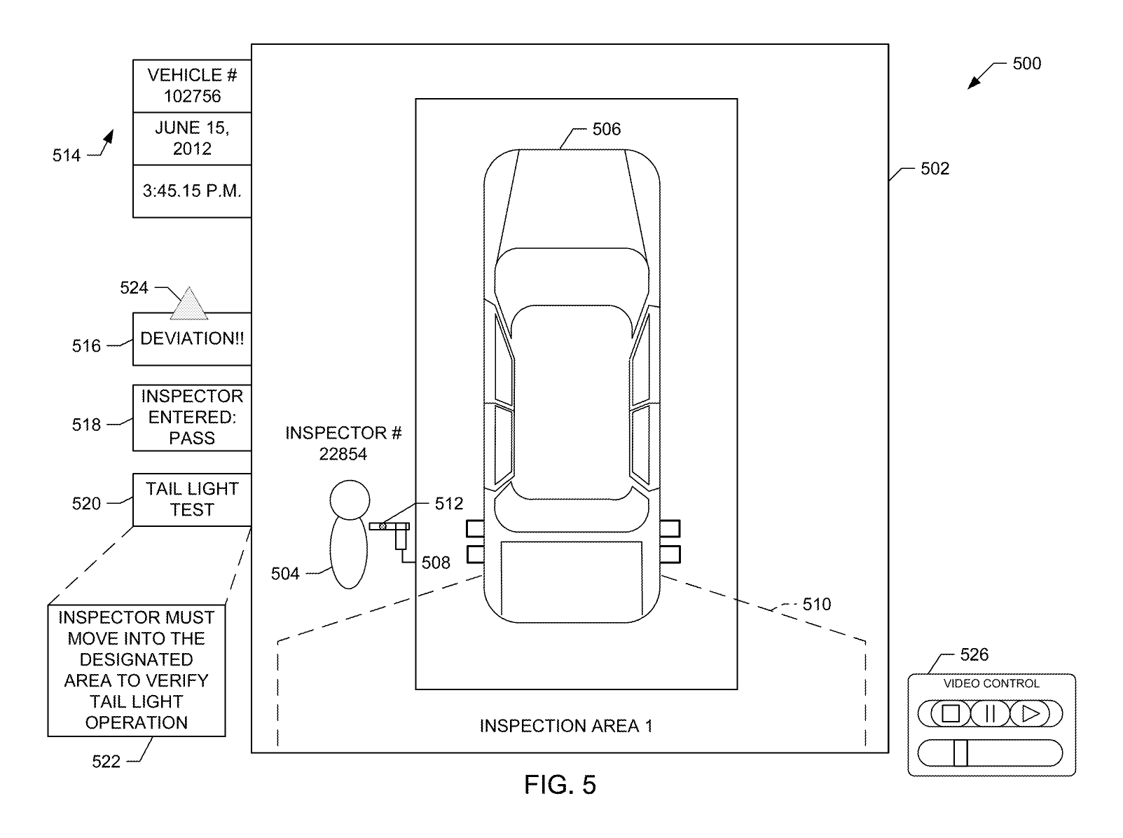

FIG. 5 shows a video playback 500 of workflow data including a recorded inspection that triggered a flag or deviation because an inspector improperly performed an inspection test. The example video playback 500 includes a video image 502 recorded by, for example, camera 204 (FIG. 2). The video playback 500 also includes objects 504 to 508, which are detected by the depth sensor 208 and/or the workflow data processor 132. In this example, the object 504 is the inspector, the object 506 is a vehicle, and the object 508 is a tool. The example inspector object 504 can be rendered by the workflow data processor 132 as a representative figure as is shown. In other examples, the workflow data processor 132 may render the inspector object 504 as a figurine with modeled joints and/or limbs. In this example, the rendered three-dimensional objects 504, 506 and 508 are displayed over the corresponding recorded video image 502.

In yet other examples, the workflow data processor 132 may display actual video of the inspector instead of including the inspector object 504 within the video image 502. In these examples, the workflow data processor 132 creates the inspector object 504 so that the rule analyzer 134 can compare identified motions and/or actions of the object 504 to workflow rules and/or workflow limits of allowed motions.

In the illustrated example, the video image 502 also displays a workflow rule 510. The workflow rule 510 includes an area towards the rear of the vehicle object 506 that the inspector object 504 must enter to complete a test, here a Tail Light Test as illustrated at information field 520. This particular video image 502 shows the closest that the inspector object 504 enters the area defined by the workflow rule 510 during the Tail Light Test. In this example, rule analyzer 134 (FIG. 1B) generates a flag during this procedure because the inspector object 504 has failed to enter the area defined by workflow limits of the workflow rule 510. In other examples, the workflow rule 510 may be replaced by a statistical distribution of an acceptable range of inspector motions and/or acceptable area of inspector movements.

FIG. 5 also shows an icon 512 (e.g., a painted area, a sticker, etc.) on the tool object 508. The workflow data processor 132 detects the icon 512 and cross-references the icon 512 to the tool object 508. In examples in which a workflow rule includes an action to be performed with the tool object 508, the rule analyzer 134 determines if the inspector object 504 moves tool object 508 into the appropriate location. Tool object 508 can be colored or display a logo so that the tool can be detected and monitored. For example, tool object 508 could have a red end and a blue end. Controller 120A and/or 120B can be configured to look for a particular pattern of movement from the colored ends, e.g., blue end rotating relative to red end, blue and red ends rotating about a same arc, or blue and red being translated together in a specified pattern, etc., to indicate that the tool is being used properly and potentially to confirm that the tool object 508 has been used long enough to complete a particular task. Color stacking or shape stacking, e.g., a pressure gauge placed onto the automobile's tire, are two example ways of ensuring tool 508 has been properly used.

Color can be used additionally to indicate a test result, e.g., a green card for pass and a red card for fail. Color can be used to indicate direction or location, e.g., a left versus right taillight. An automobile's color can also be used to ensure that the vehicle matches that listed on a vehicle identification number (“VIN”) registered to the driver.

In some examples, the icon 512 may include a directional indicator, which can be detected by the workflow data processor 132 to determine an orientation and/or position of the tool object 508. Rule analyzer 134 may then use the orientation to determine if the inspector is holding the tool object 508 in a specified manner. In other instances, rule analyzer 134 may use the orientation to determine if a procedure has been performed properly or quantify a parameter. For example, the orientation could be used with a duration that object 508 remains in the orientation to determine an amount of oil poured by an inspector into an engine. The determined amount of oil, or the fact that oil has been poured at all, may later be compared to an actual oil use and/or to an amount charged to a customer to ensure the operator has not shorted the amount of oil being used and/or charged or that the automobile driver has not been charged for receiving no oil.

The example video playback 500 of FIG. 5 also includes vehicle, inspector identification information and other identification information that may be received, for example, from the inspection terminal 220 of FIG. 2. The example workflow data processor 132 combines this workflow data with the video and objects for the video playback 500. This information includes a situational information field 514 (e.g., vehicle inspection number, time, date, etc.), a test result information field 516 (e.g., deviation), and current test information fields 518, 520 and 522. The test rules information field 516 is displayed adjacent to a graphic symbol 524 to visually indicate a result of the test/procedure. The test information field 518 includes a test result entered by the inspector test field 520 includes a test being performed by the inspector. Test field 522 includes a description of the workflow rule 510. The example video image 500 may also include additional inspection information, such as the results of the previous steps of the overall emissions test and/or a list of remaining steps to be displayed in the replay video.

FIG. 5 also shows a control panel 526 that enables an auditor (e.g., the field personnel 110 of FIG. 1A) to pause, stop, play, fast forward, and/or rewind the video playback 500. For example, an auditor may select a play function to watch the inspector object 504 performing the inspection of the vehicle 506. In some examples, the control panel 526 may include bookmarks that enable an auditor to select a particular inspection procedure, inspection procedures that have been flagged, and/or video images of particular concern to the auditor.

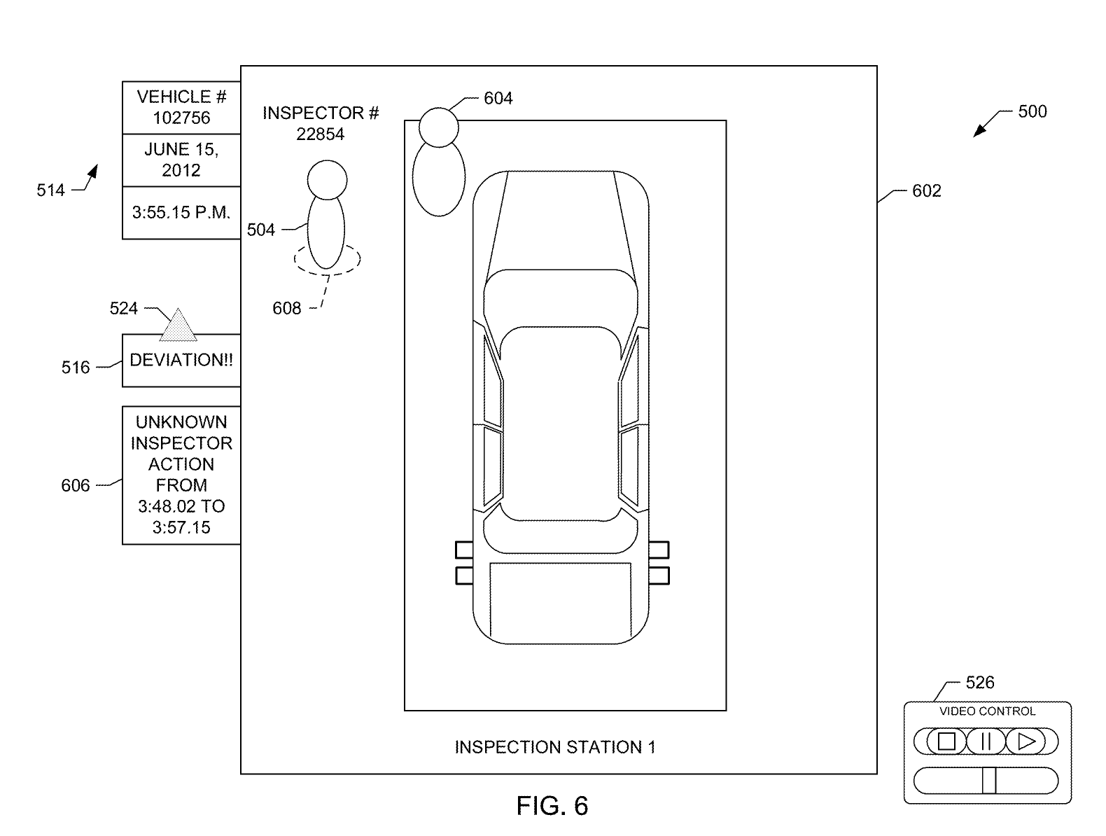

FIG. 6 shows the video playback 500 of FIG. 5 displaying a video image 602. The example video image 602 shows the inspector object 504 inspecting the vehicle 506 at a time ten minutes later from the video image 502. In this example, the inspector object 504 is flagged by the rule analyzer 134 for performing an unknown action (e.g., talking to an associate 604 for a relatively long period of time). The video playback 500 includes the test result information field 516 and the graphic symbol 524 indicating the deviation and/or flag. The example video playback 500 also includes a message field 606 that indicates why the inspector object 504 was flagged by the rule analyzer 134. The example video image 602 also includes a highlight 608 of the detected unknown action of the operator object 504.

It should be appreciated that FIGS. 5 and 6 show two example video images 502 and 602 that can be created by the workflow data processor 132 based on processing recorded audio, video, and/or depth data into workflow data. Other examples may include inspectors performing other actions and/or motions. Additionally, other examples can include inspectors using different tools. Further, other examples can show different workflow rules and/or distributions of allowable inspector actions.

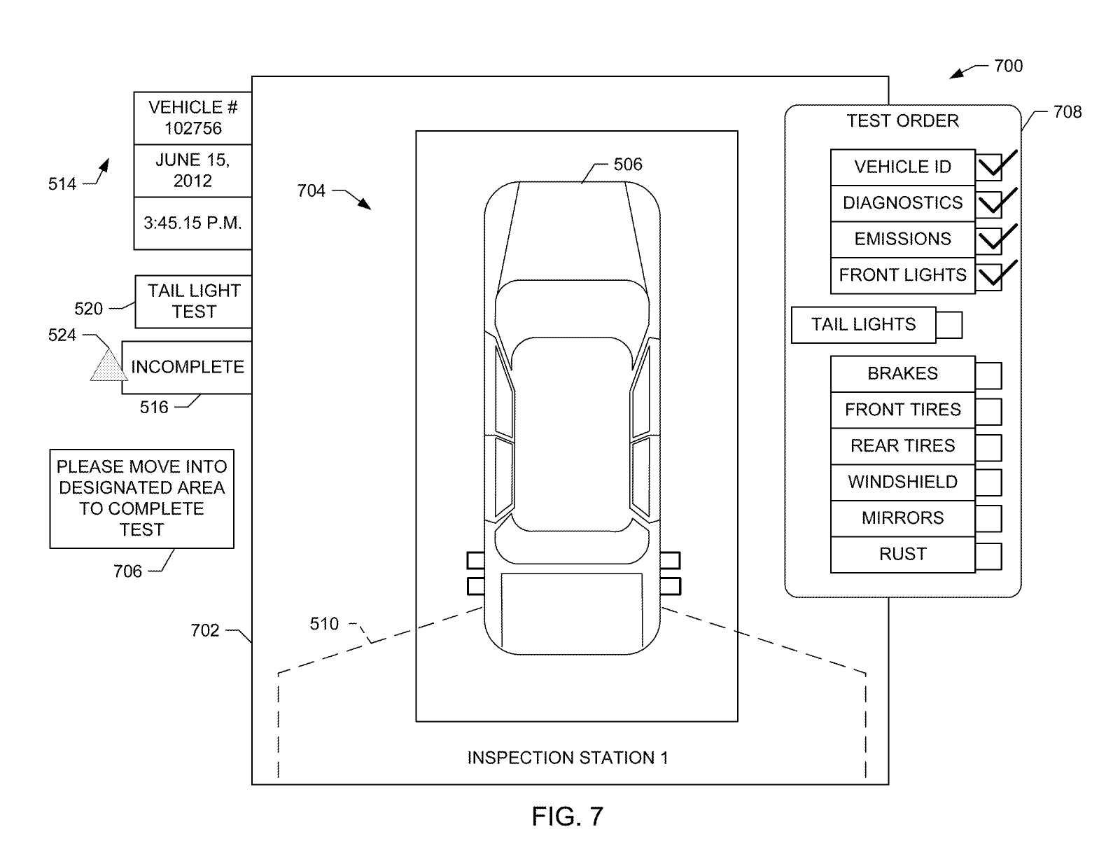

FIG. 7 shows an operator control panel 700 operated by the test system controller 120A and/or 120B of FIGS. 2 to 4. The example operator control panel 700 provides quality control for vehicle inspections and can be viewed by an inspector on the inspection terminal 220. In some examples, the operator control panel 700 may prevent an inspector from beginning an inspection procedure until a current procedure is completed. In other examples, the operator control panel 700 informs an inspector of actions to perform to complete previously incomplete inspection procedures.

The operator control panel 700 of the illustrated example includes a video image 702 of an inspection area 704. The video image includes the vehicle object 506 and the workflow rule 510, which corresponds to the current procedure being performed by the inspector. In some examples, the video image 702 can include the inspector object 504 of FIG. 5 when an inspector is in the display area. The example video image 702 is displayed in real-time by the example test system controller 120.

In this example, the operator control panel 700 includes the situational information fields 514, the test result information field 516 including the graphic symbol 524, and the test information field 520. The operator control panel 700 also includes an instruction field 706, which displays instructions for an inspector to satisfy a workflow rule (e.g., the workflow rule 510). The instructions in the field 706 correspond to which procedure an inspector is performing and/or correspond to which workflow rule and/or workflow limit is being applied by the rule analyzer 134.

Operator control panel 700 also includes a test script 708. Test script 708 in one embodiment includes a list and/or descriptions of inspection procedures than an inspector is to perform. Test script 708 may also record procedure results entered by an inspector and/or recorded by a camera system. The test system processor 142 (FIG. 1B) may control and/or manage the test script 708.

In this example, the test script 708 shows that the Vehicle ID, Diagnostics, Emissions, and Front Lights procedures have been completed successfully. The test script 708 also shows that the inspector is currently performing a Tail Light Test. In some examples, the workflow data processor 132 may detect which procedure an inspector is performing based upon actions of the inspector (e.g., noting an inspector has successfully completed a procedure and selecting a next procedure in a test order). In other examples, the inspector can enter which procedure is being performed.

In the illustrated example, the example rule analyzer 134 determines that an inspector has not successfully completed the Tail Lights Test. As a result, the test system processor 142 displays in the test result information field 516 that the Tail Light Test is incomplete. The test system processor 142 also transmits the text for the instruction field 716. Test system processor 142 also prevents the inspector from beginning the next procedure (e.g., the Brake test) until the Tail Lights Test is complete. In this manner, the example test system controller 120 provides process control to ensure an inspection is completed according to jurisdictional standards.

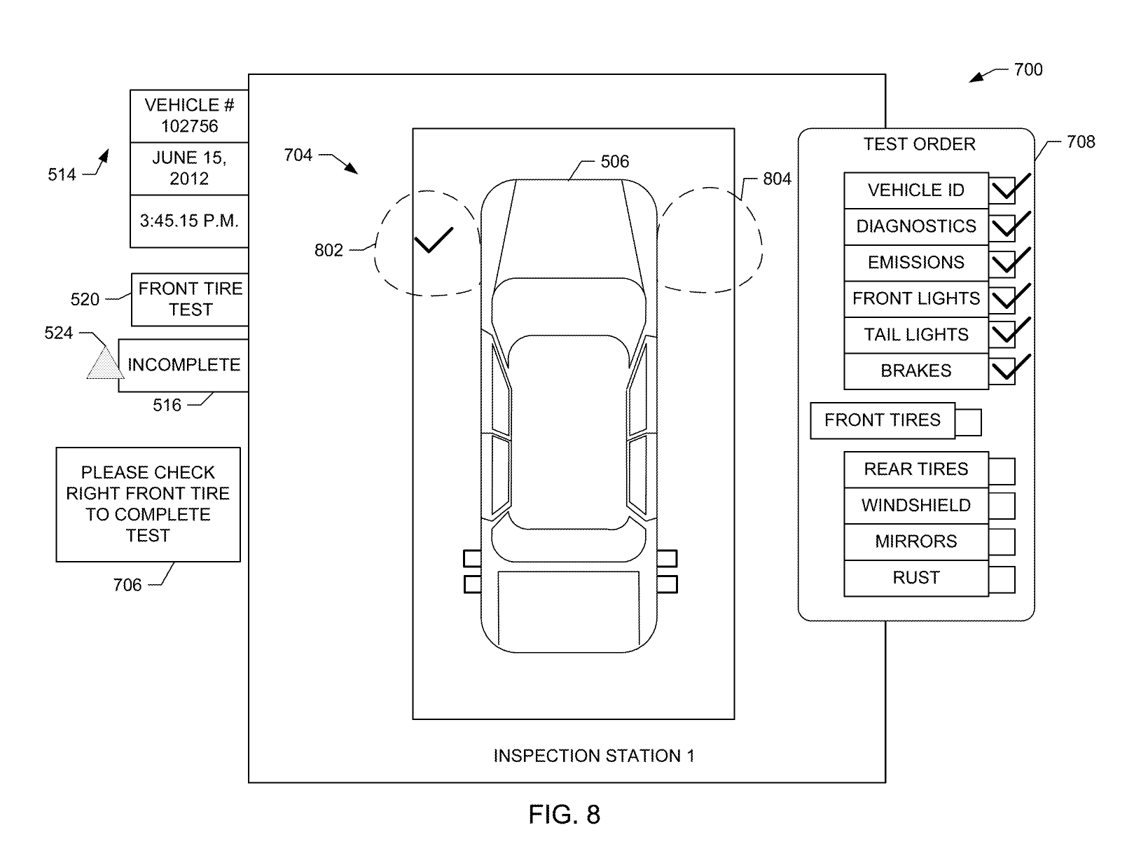

FIG. 8 shows the example operator control panel 700 of FIG. 7 with the example test script 708 indicating an inspector is currently conducting a Front Tires Test. In this example, the Front Tire Test is associated with workflow rules 802 and 804, which indicate an inspector is to move into an area in proximity to the two front tires of the vehicle 506 to properly perform the inspection test. In some examples, the workflow rules 802 and 804 may also specify that the inspector is to remain in an area defined by the workflow rules 802 and 804 for a predetermined period of time. This period of time may correspond to an average time to complete, for example, the Front Tire Test.

Test result information field 516 and/or the graphic symbol 524 show that the Front Tire Test is incomplete. The instruction field 706 informs an inspector that the Front Tire Test is incomplete because the inspector did not move into an area defined by the workflow rule 804. Additionally, the workflow rule 802 includes a check mark to visually indicate to the operator that a portion of the Front Tire Test is complete.

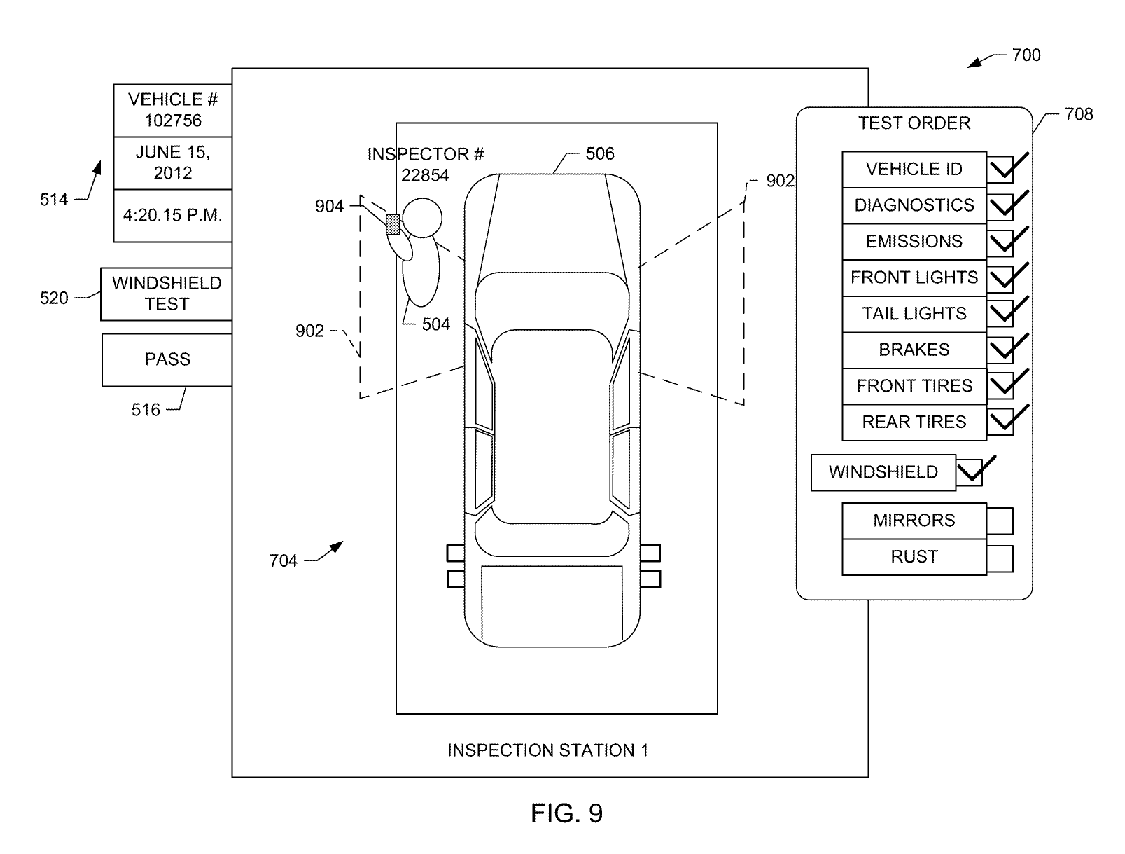

FIG. 9 shows the example operator control panel 700 of FIG. 7 with the example test script 708 indicating an inspector has completed a Windshield Test. In this example, the test information field 520 indicates workflow rule 902 is associated with the Windshield Test. The test result information field 516 indicates that the Windshield test is complete.

In the illustrated example, the operator control panel 700 shows the inspector object 504 displayed over video of the inspection area 704. In this example, the inspector object 504 is within an area defined by the workflow rule 902. Rule analyzer 134 (FIG. 1B) determines that inspector object 504 has satisfied by the workflow rule 902 by moving into one of the two defined areas adjacent to the windshield of the vehicle 506.

The example of FIG. 9 also shows that inspector object 504 holds an indicator 904. The indicator 904 is detected by the workflow data processor 132 (FIG. 1B) based on a color, shape, and/or patterning. In other examples, the indicator 904 may emit an RFID signal, a light, or other signal than can be detected by, for example, the camera system 202 and/or identified by the workflow data processor 132. In yet other examples, the indicator 904 can include a body motion by the inspector object 504 (e.g., signaling a thumbs-up). Additionally, the indicator 904 can include a voice command detected and/or recorded by a microphone illustrated and described above.

In this example, the rule analyzer 134 determines the indicator 904 is meant to indicate that the procedure has been completed successfully. Accordingly, the rule analyzer 134 and/or the test system processor 142 updates the Windshield Test as having been passed. The test system processor 142 then enables the inspector to begin the Mirrors Test.

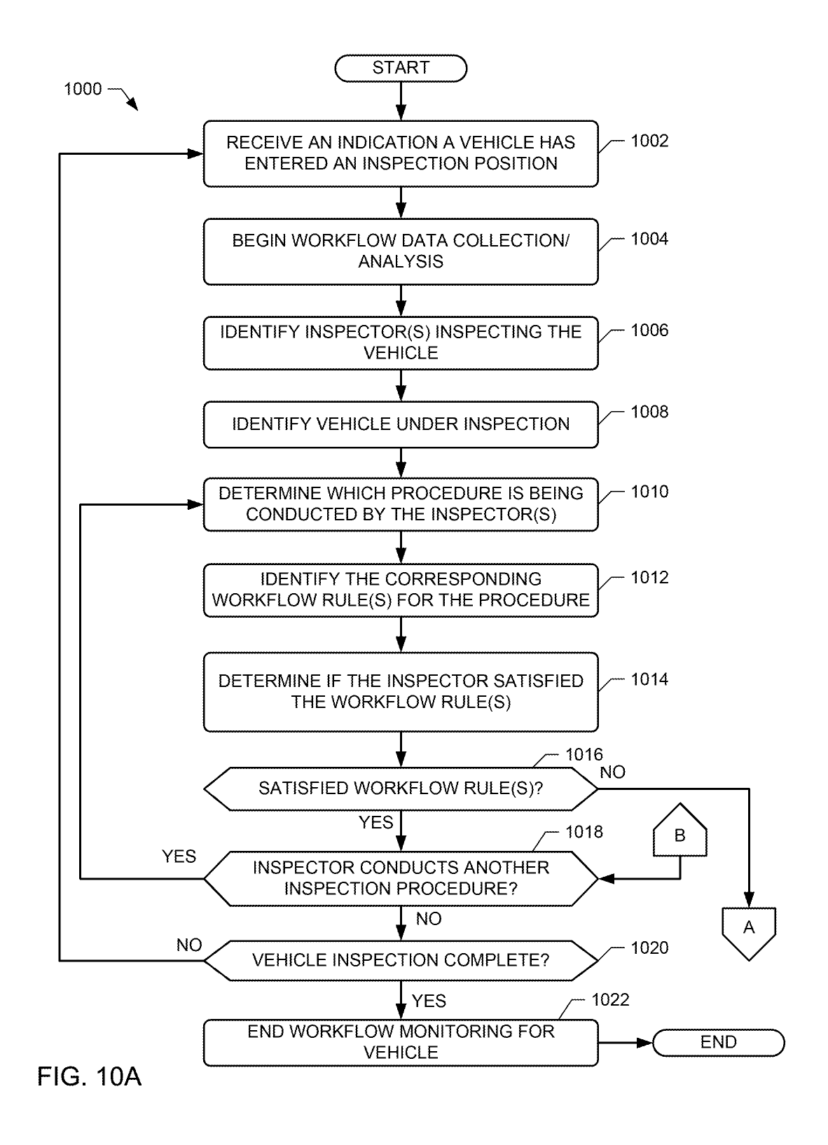

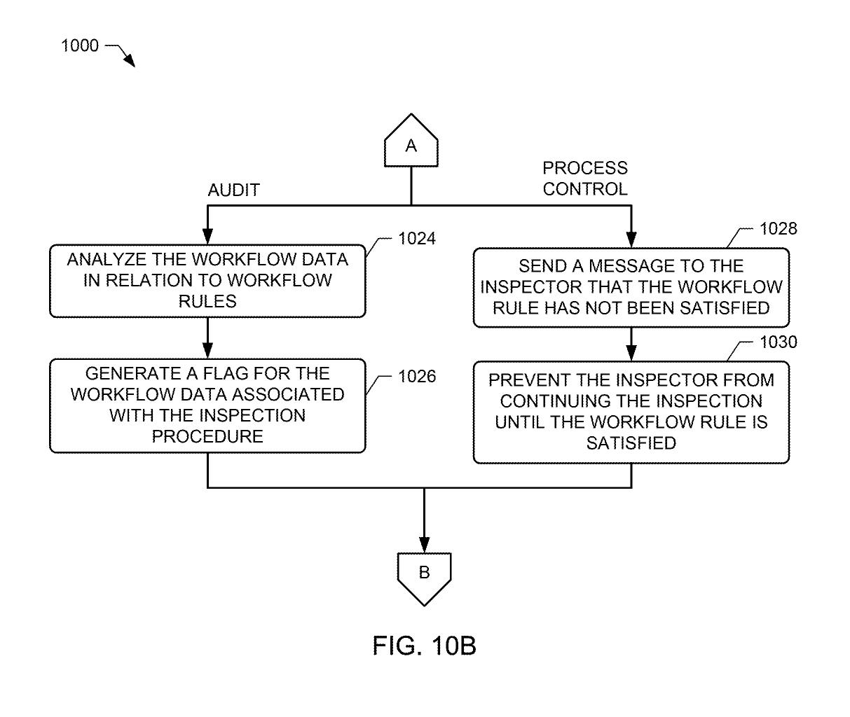

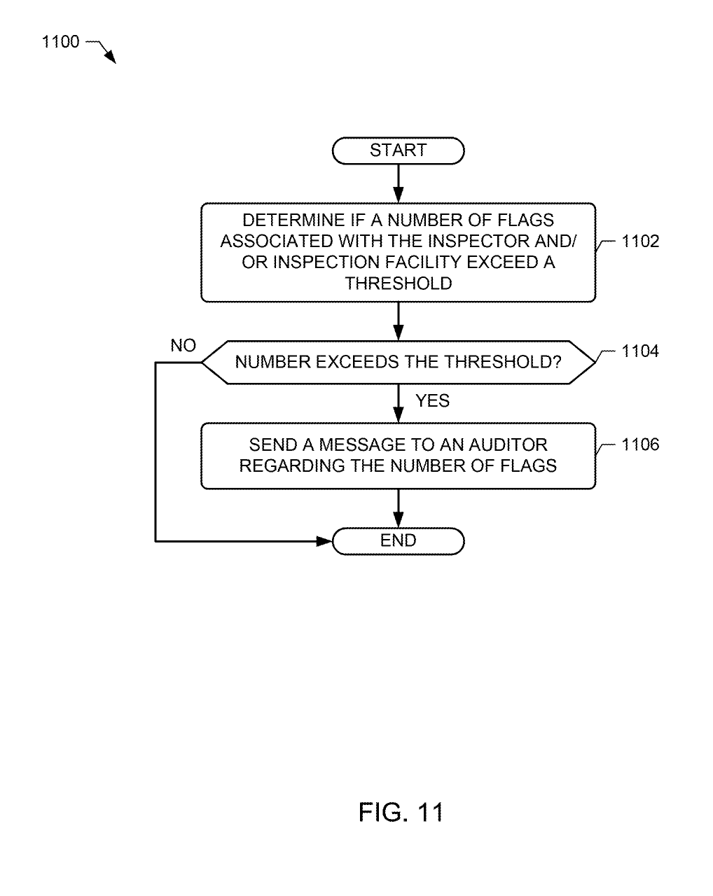

FIGS. 10A, 10B, and 11 depict example flow diagrams representative of processes that may be implemented using, for example, computer readable instructions that may be used to monitor inspector work flows. The example processes of FIGS. 10A, 10B, and 11 may be performed using a processor, a controller and/or any other suitable processing device. For example, the example processes of FIGS. 10A, 10B, and 11 may be implemented using coded instructions (e.g., computer readable instructions) stored on a tangible computer readable medium such as a flash memory, a ROM, and/or a RAM. As used herein, the term tangible computer readable medium includes any type of computer readable storage and to exclude propagating signals. The example processes of FIGS. 10A, 10B, and 11 may be implemented using coded instructions (e.g., computer readable instructions) stored on a non-transitory computer readable medium such as a flash memory, ROM, RAM, a cache, or other storage media in which information is stored for any duration (e.g., for extended time periods, permanently, brief instances, for temporarily buffering, and/or for caching of the information). As used herein, the term non-transitory computer readable medium includes any type of computer readable medium and to exclude propagating signals.

Alternatively, some or all of the example processes of FIGS. 10A, 10B, and 11 may be implemented using any combination(s) of application specific integrated circuit(s) (ASIC(s)), programmable logic device(s) (PLD(s)), field programmable logic device(s) (FPLD(s)), discrete logic, hardware, firmware, etc. Also, some or all of the example processes of FIGS. 10A, 10B, and 11 may be implemented manually or as any combination(s) of any of the foregoing techniques, for example, any combination of firmware, software, discrete logic and/or hardware. Further, although the example processes of FIGS. 10A, 10B, and 11 are described with reference to the flow diagrams of FIGS. 10A, 10B, and 11, other methods of implementing the processes of FIGS. 10A, 10B, and 11 may be employed. For example, the order of execution of the blocks may be changed, and/or some of the blocks described may be changed, eliminated, sub-divided, or combined. Additionally, any or all of the example processes of FIGS. 10A, 10B, and 11 may be performed sequentially and/or in parallel by, for example, separate processing threads, processors, devices, discrete logic, circuits, etc.

The example process 1000 of FIGS. 10A and 10B monitor an inspector to determine if a vehicle inspection is performed according to jurisdictional standards. The example process 1000 begins by the example receiver 130 of FIG. 1B receiving an indication a vehicle has entered an inspection station (block 1002). For example, camera system 202 may detect the vehicle. The example workflow data processor then begins processing video, audio, and/or depth data recorded by the camera system 202 into workflow data (block 1004). This includes processing recoded data into into one or more three or two-dimensional renderings (e.g., workflow data).

The example workflow data processor 132 and/or the rule analyzer 134 also identifies inspector(s) inspecting the vehicle (block 1006). The workflow data processor 132 and/or the rule analyzer 134 then identifies the vehicle under inspection (block 1008). In some instances, the inspector may input the vehicle identification number (“VIN”) or the license plate number or acquire the VIN via an On-Board Diagnostics (“OBD”) port. In other instances, the workflow data processor 132 and/or the rule analyzer 134 identifies the vehicle by matching detected vehicle color, shape, dimensions, or engine noise to similar data stored and referenced to vehicle identification information in the test system database 122. Upon identifying a vehicle, the workflow data processor 132 begins time-stamping the workflow data with information corresponding to the vehicle, time/day, inspector, and procedures to be performed.

After identifying the vehicle, the workflow data processor 132 and/or the rule analyzer 134 identifies which procedure is being conducted by the inspector(s) (block 1010). In some instances, the inspector can provide the procedure. In other instances, the procedure can be determined by matching actions being performed by an inspector and specified in workflow data to a corresponding procedure. Based on the identified inspection procedure, the example rule analyzer 134 determines which workflow rule(s) correspond to the procedure (block 1012). The rule analyzer 134 then determines if the inspector satisfied the workflow rule by comparing workflow data to workflow limits of the workflow rule (block 1014). In some examples, the rule analyzer 134 may also determine if an inspector was within a distribution of the workflow limit.

In response to the rule analyzer determining a workflow rule has been completed (block 1016), the example workflow data processor 132 and/or the test system processor 142 determines if the inspector is to conduct another inspection procedure (block 1018). Additionally, test system processor 142 may indicate in a test script that the inspection procedure has been passed and enable the inspector to begin the next inspection procedure.

If the inspector is conducting another inspection procedure, the workflow data processor 132 determines which procedure is being performed (block 1010). Alternatively, the test system processor 142 may indicate the next procedure to be performed. However, if the inspector does not conduct another inspection procedure, the example test system processor 142 determines if the vehicle inspection is complete (block 1020). If the vehicle inspection is not complete (e.g., the vehicle is moved to a next inspection position), the workflow data processor 132 receives an indication the vehicle has entered the next inspection position (block 1002). If the vehicle inspection is complete, the workflow data processor 132 ends the monitoring of vehicle inspection session (block 1022). Additionally, the workflow data processor 132 may store the workflow data generated during the session to the test system database 122.

If in block 1016 the workflow rules have not been satisfied, the example audit analyzer 136 analyzes the workflow data of the inspector in relation to the workflow rule and/or a workflow limit distribution to determine the extent that the workflow rule has been violated (block 1024, “A” to “A”). The audit analyzer 136 then generates a flag or indication of a deviation for the portion of the workflow data associated with the inspection procedure (block 1026). The example test system processor 142 then waits until the compliance analyzer 138 indicates whether the inspection can continue. In some examples, the audit analyzer 136 may perform the processes of blocks 1024 and 1026 after an inspection.

Additionally, if the workflow rules have not been satisfied, the example test system processor 142 performs a process control function by sending a message to the inspector indicating that the workflow rule has not been satisfied (block 1028). The example test system processor 142 may also prevent the inspector from beginning the next inspection procedure until the workflow rule is satisfied (block 1030). Once the compliance analyzer 138 has indicated the inspector can continue with the inspection, the example test system processor 142 then determines if another inspection procedure is to be conducted (block 1018, “B” to “B”). The process 1000 then continues until the vehicle inspection has ended and workflow monitoring of the vehicle can cease (block 1022).

The example process 1100 of FIG. 11 determines whether to alert an auditor that an inspector and/or inspection facility has an unallowable amount of deviations or indications in response to receiving a trigger and/or alert. Process 1100 begins in one embodiment by the audit analyzer 136 compiling flags or indications associated with an inspector and/or an inspection facility (block 1102). The example audit analyzer 136 then determines if the number of flags exceeds a threshold (block 1104). If the number of flags exceeds a threshold, the example audit analyzer 136 sends an instruction to the audit facility 106 via the audit management system 140 notifying auditors about the number of flags for a particular inspection facility and/or inspector (block 1106). After transmitting the notification, the example process 1100 terminates. Additionally, the process 1100 terminates after the audit analyzer 136 determines that the number of flags or deviations does not exceed a threshold.

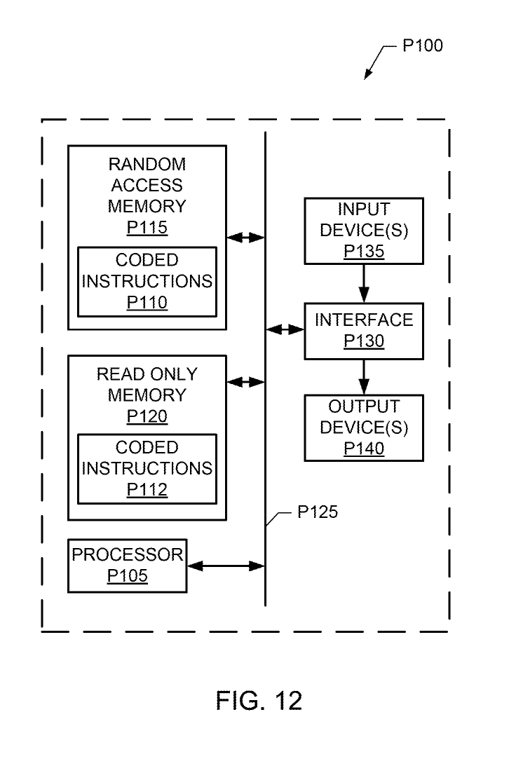

FIG. 12 is a schematic diagram of an example processor platform P100 that may be used and/or programmed to implement the example receiver 130, the example workflow data processor 132, the example rule analyzer 134, the example audit analyzer 136, the example compliance analyzer 138, the example audit management system 140, the example test system processor 142 and/or more generally, the example test system controller 120 of FIG. 1B. For example, the processor platform P100 can be implemented by one or more general-purpose processor, processor core, or microcontroller, etc.

The processor platform P100 of the example of FIG. 12 includes at least one general purpose programmable processor P105. The processor P105 executes coded instructions P110 and/or P112 present in main memory of the processor P105 (e.g., within a RAM P115 and/or a ROM P120). The processor P105 may be any type of processing unit, such as a processor core, a processor and/or a microcontroller. The processor P105 may execute, among other things, the example processes of FIGS. 10A, 10B, and/or 11 to implement the example methods and apparatus described herein.

The processor P105 is in communication with the main memory (including a ROM P120 and/or the RAM P115) via a bus P125. The RAM P115 may be implemented by DRAM, SDRAM, and/or any other type of RAM device, and ROM may be implemented by flash memory and/or any other desired type of memory device. Access to the memory P115 and the memory P120 may be controlled by a memory controller (not shown). One or both of the example memories P115 and P120 may be used to implement the example test system database 122 and/or the database 152 of FIGS. 1A to 1C.

The processor platform P100 also includes an interface circuit P130. The interface circuit P130 may be implemented by any type of interface standard, such as an external memory interface, serial port, general-purpose input/output, etc. One or more input devices P135 and one or more output devices P140 are connected to the interface circuit P130.

Additionally, although this patent discloses example systems including software or firmware executed on hardware, it should be noted that such systems are merely illustrative and should not be considered as limiting. For example, it is contemplated that any or all of these hardware and software components could be embodied exclusively in hardware, exclusively in software, exclusively in firmware or in some combination of hardware, firmware and/or software. Accordingly, while the above specification described example systems, methods and articles of manufacture, the examples are not the only way to implement such systems, methods and articles of manufacture. Therefore, although certain example methods, apparatus and articles of manufacture have been described herein, the scope of coverage of this patent is not limited thereto. To the contrary, this patent covers all methods, apparatus and articles of manufacture fairly falling within the scope of the appended claims either literally or under the doctrine of equivalents.

Vehicle Inspection Example

One example vehicle inspection procedure uses a combination of video and audio. To allow flexibility and to preserve resources, test system controller 120 in essence waits for the next inspector signal before activating the camera system. Activating the camera systems only when needed conserves memory and reduces the amount of non-usefully or non-critical video. The next signal in one embodiment is voice activated. The inspector 114 may say “start test, VIN (read number)”. Controller 120 enters the VIN, calls forth the appropriate procedure for the particular VIN, and awaits the next voice command. The particular inspection may include N number of test procedures P_{A}, P_{B}, P_{C} . . . P_{N}. Controller 120 can require the N procedures to be done in a particular order. Or, the controller can allow inspector 114 to perform the procedures in an order convenient for the inspector given the inspector's current location and vehicle type. It is important that all of the N number of test or inspection procedures are performed, but the order is not important in one embodiment. The N number of procedures can be displayed to inspector 114 either at a video monitor associated with controller 120 or on a handheld device carried by inspector 114 that can be in wireless communication with the system.

Once inspector 114 announces a test or inspection procedure, e.g., “windshield wiper”, controller 120 activates the camera system and implements one or more two-dimensional or three-dimensional workflow rule discussed above. Controller 120 also adds a fourth-dimensional check, which is time. For example, using the windshield wiper test procedure, controller 120 is programmed to expect inspector 114 to reach the area of the vehicle, according to the particular VIN, where the windshield wiper activator is located. Controller 120 is programmed to expect inspector 114 to (i) reach the windshield wiper activator area of the vehicle within a certain duration and (ii) to remain at the windshield activation area for a time duration that is deemed reasonable to activate the windshield wipers and to observe if the wipers are operational. If check (i) times out before being satisfied the controller 120 can prompt the inspector to complete the windshield test procedure and start the windshield wiper timer over or require the entire procedure to start over. If (ii) is not satisfied, then the controller 120 can (a) prompt the inspector to re-perform the windshield wiper inspection procedure; (b) allow the test procedure to continue but flag the procedural lapse for quality assurance (here audit analyzer 136 acts as QA); (c) perform both (a) and (b), such that the controller 120 tries to ensure that the inspection procedure is performed correctly and notes when an inspector has not performed a test procedure properly.

Controller 120 may or may not be configured to look via the camera system to see if the windshield wipers actually moved. Here again, controller 120 can be programmed to operate in a number of different ways. In a first way, the inspector observes the wipers working or not working and announces, “pass” or “fail” or “windshield wiper pass” or “windshield wiper fail” depending upon whether it is desired or not to remind controller 120 that the current procedure is for a windshield wiper test. Again, in the example the system is in a windshield wiper procedure mode. In this first way, controller 120 does not look for the windshield wipers to actually move. It is assumed that if inspector 114 moves to the appropriate activation area and remains in the area long enough, that the inspector will follow through and correctly observe the windshield wipers move or not move.

In a second way, the camera system looks for the windshield wipers to move or not to move during the time that inspector 114 resides in the windshield wiper activation area. If the controller 120 observes the wipers moving the procedure is passed, if not the procedure is failed. The inspector is freed from having to make a determination and an input.

In a third way, the test system controller 120 looks for the wipers to move and for the inspector to call out “pass” or “fail” or “windshield wiper pass” or “windshield wiper fail”. Here, controller 120 can compare the two responses. If consistent, a successful inspection procedure performance can be confirmed. If inconsistent, controller 120 can prompt inspector 114 to re-perform the procedure or trust the video result and note the inspector inconsistency for an audit.

In any of the first, second and third ways, it is also contemplated that controller 120 visually to verify that inspector 114 makes one or more actions while at the area specified for the particular procedure. For example, controller 120 could verify that the inspector has inserted a probe for a tailpipe test.

In the example, controller 120 waits for inspector 114 to initiate a new test or inspection procedure once a result for a prior procedure is obtained. For example, once controller 120 obtains workflow data for the windshield wiper procedure, the system waits for the inspector to initiate the next one of the N number of procedures until all of the N procedures of the area test have been performed. The inspector can be allowed to optimize the order of the performance of the test procedures accordingly to his or her discretion. Alternatively, controller 120 can require the inspector to run through the N procedures of the test in a specified order.

While voice activation is one way for the procedure to be controlled, it is contemplated to control the procedure using other sound or visual cues. For example, an inspector can be provided with a handheld unit. The handheld unit can be provided with a button for each of the N procedures. Once one of the buttons is pressed, a signal is emitted that has a certain frequency or pattern specific to the selected procedure. The signal can be sub-sonic or ultra-sonic so that it need not be heard as long as camera system or controller 120 is equipped with the proper receiver. The pass/fail answer signal can likewise have its own frequency or pattern. Upon receiving a pass or fail sound signal from the handheld device, controller 120 waits for the next of the N procedures to be inputted by its specific sound frequency or pattern output from the device. Inspector 120 here runs through the procedure as before but uses the handheld sound outputting device to initiate and run through the procedure as opposed to using the voice activated commands as described previously. Pass versus fail for any given procedure can be determined from camera system observation alternatively or additionally as has been discussed above.

Further alternatively, the handheld device illuminates a character or pulses lights at a certain frequency or pattern to initiate a particular test procedure or to signal pass versus fail. The inspector points the illuminated image briefly towards a camera for communication between the handheld devices and the camera. The handheld device can for example illuminate “WW” when the windshield wiper button is pressed, “LHL for left head light, “P” for pass, etc. The letters “WW”, “LHL”, “P” can be replaced by a Braille-like series of illuminated dots. Or, different colors or different color patterns can be used to signal the start of an inspection, to signal a start of a particular test procedure or to signal pass versus fail. Any and all of the alternatives discussed above for the voice or sound-activated systems, such as camera motion detection for pass versus fail, are contemplated for the visual output control of controller 120, which may be advantageous because controller 120 may be less prone to errors due to environmental noise.

For any of the voice, sound and visual versions of camera system 118, it is contemplated for controller 120 to provide feedback or handshaking to an inspector. In one example, controller 120 provides an overhead video monitor that the inspector can see from anywhere or virtually anywhere in the vicinity of the vehicle. The video monitor, after determining the proper test or inspection to perform, can display a column of symbols, e.g., “LHL”, “RHL”, “RTL”, “LTL”, “EXH”, “LTS”, “RTS”, “WW”. The video monitor in this manner provides feedback to the inspector upon initiation of the inspection or procedure that the system is ready to perform same. The symbols can be displayed top to bottom according to a preferred or optimal order, which can be dependent upon the inspector's starting location relative to the vehicle.

When inspector 114 annunciates “exhaust”, or presses a button emitting a sound pattern corresponding to “EXH”, or presses a button illuminating or flashing the symbol “EXH” towards the camera system, controller 120 can handshake with the inspector by flashing or otherwise highlighting the symbol “EXH” on the overhead video monitor. The exhaust test procedure is now activated and the camera system 118 and/or the test system controller 120 is commanded to look for inspector 114 to react accordingly, e.g., walk to the vehicle's tailpipe with a probe. The probe and other tools of the procedure or inspection can be provided as part of the handheld device to reduce the hardware that the operator needs to transport.

The probe takes an exhaust reading, which can result in a “P” or “F” on the handheld display or in a readout number that controller 120 reads, records and categorizes as pass or fail. Or, the handheld device can emit a pass or fail sound. Or, inspector 114 can annunciate “pass” or “fail”. The flashing “EXH” symbol on the video monitor then stops flashing, providing further feedback to the inspector that a procedure of the inspection or test has been completed. The “EXH” symbol can then be dimmed, highlighting the remaining symbols, or be marked with an adjacent “P” or “F” showing not only completion, but also result. Test system controller 120 then waits for inspector 114 to initiate the next test procedure or guides the inspector to the next test procedure as desired. At the end of N procedures, controller 120, e.g., at the overhead video monitor can sound a siren, flash a light, show a message, e.g., “inspection completed,” or any combination thereof.

Medical Applications

As discussed, the teachings, principles and advantages of the present disclosure are not limited to vehicle inspections. For instance, the above examples can be applied to medical applications. In one embodiment, medical disorders, such as sleeping disorders (e.g., sleep apnea) can be captured and analyzed via a workflow data processor, e.g., which do not just record when a person moves but can count how many moves, categorize the types of moves and analyze which moves tend to lead to the patient awakening, for example. The results of the analysis are provided in a form useful for a medical professional.

In another embodiment, a medical system processor verifies, for example, surgical instrumentation counts, sponge counts, equipment counts, and/or significant events in an operating room (e.g., a medical professional connection an infusion machine to a patient). In this embodiment, the medical system processor may include a library of every surgical instrument and can recognize and count instruments from any surgical tray.

Each tray can include a barcode, Near Field Communication (“NFC”), Radio-Frequency Identification (“RFID”), or Quick Response (“QR”) code on a cover that a camera system scans to determine which instruments are supposed to be contained in the tray. This can be used for quality assurance purposes by central supply or autoclaving staff to verify which instruments are contained in trays. The medical system processor uses workflow data to determine actual tray contents and compare the actual contents to the anticipated contents. The medical system processor may recognize or identify instruments based on, for example, color coded tags or identifiers.

In some instances, the medical system processor may track locations of the surgical instruments throughout an operating room and make the locations of these instruments graphically available to medical personnel via a display. For example, the medical system processor may display on a graphical representation of an operating room locations for different surgical instruments. Medical personnel may use the medical system processor to filter or search for a particular instrument.

In another example, the medical system processor can track which medical implants and/or surgical instruments have been implanted into a patient. As a result, the medical system processor may provide an alert if a medical instrument is inadvertently left inside of a patient, if a sutures or needle is unaccounted, if a medical implant is not in an anticipated location, or if medical instruments are removed from a procedure area. Further, the medical system processor can verify that the correct equipment is used for a medical procedure. For instance, the medical system processor can verify that a defined microscope, surgical tray, laser, laparoscopic tower/equipment, infusion pump, etc., is being used for a particular procedure. Additionally, the medical system processor can use recorded data to identify drug labels, syringe labels, or medicine dispensing container labels. For instance, the medical system processor can use the identifying of medical labels to determine which medication has been dispensed to a patient at a particular time. The medical system processor may also determine whether the patient received the proper dosage.

In a further example, the medical system processor can determine whether medical performed specified actions or functions. For instance, the medical system processor can use recorded data from a camera system to determine whether medical personnel performed hand sterilization in a washing terminal using required a required hand sanitizer. The medical system processor may also monitor cleaning crews to provide quality assurance that operating rooms have been properly cleaned and sanitized.

In addition to using recorded video, depth, and RF data, the medical system processor may also monitor medical procedures using audio. For example, a surgeon says “incision”, causing the medical system processor to automatically log the incision event, a time/date of the incision, and associate video data with the incision event. Other events can include, fore example, a patient entering a room, anesthesia being applied to a patient, a first time out, a final time out, surgical site verification, administration of antibiotics, incisions, an end to a medical procedure, extubation, or a patient leaving a room.

Other Examples

The above examples can also be applied to many types of industrial, manufacturing and service sector quality control. The actions verified do not have to involve multiple procedures. If a single action is critical enough, the action can warrant the video data inspection and analysis described herein. A critical weld that is soon hidden during manufacture can be captured on camera, analyzed and categorized. The introduction of ingredients into a food or drink item can be verified via the present video data systems and methods. In restaurants, the systems can be used to ensure consistent and accurate food and drink preparation. In banking, the systems, can be used to record and tabulate how much money has actually been paid out or received from a customer.

The above examples are in no way an exhaustive list of the application of system 100 and its corresponding methodology.

Additional Aspects of the Present Disclosure

Aspects of the subject matter described herein may be useful alone or in combination one or more other aspect described herein. Without limiting the foregoing description, in a first aspect of the present disclosure, a method for monitoring an inspection workflow includes (i) identifying an operator in an inspection area inspecting a vehicle; (ii) determining an inspection test being performed by the operator; (iii) determining a workflow rule associated with the inspection test; (iv) determining position information of the operator within the inspection area, the position information being determined from video and depth data of the inspection area; (v) applying the workflow rule to the position information to determine if the operator moved into an area defined by the workflow rule to conduct the inspection test; and (vi) generating an indication that the operator did not move into the area.

In accordance with a second aspect of the present disclosure, which may be used in combination with the first aspect, the method further includes preventing the operator from beginning a second inspection test until the operator satisfies the workflow rule.

In accordance with a third aspect of the present disclosure, which may be used in combination with any one or more of the preceding aspects, the method further includes transmitting the indication to an auditor.

In accordance with a fourth aspect of the present disclosure, which may be used in combination with any one or more of the preceding aspects, the method further includes displaying the video and depth data of the operator performing the inspection test to the auditor.

In accordance with a fifth aspect of the present disclosure, which may be used in combination with any one or more of the preceding aspects, the method further includes counting a number of indications associated with the operator; and transmitting a message to an auditor if the number of indications exceeds a predetermined threshold.

In accordance with a sixth aspect of the present disclosure, which may be used with the fifth aspect in combination and any one or more of the preceding aspects, the predetermined threshold corresponds to the inspection test.

In accordance with a seventh aspect of the present disclosure, which may be used in combination with any one or more of the preceding aspects, a camera system tracks the operator through the inspection area.

In accordance with an eighth aspect of the present disclosure, which may be used in combination with any one or more of the preceding aspects, a camera system tracks the vehicle between inspection positions of the inspection area.

In accordance with a ninth aspect of the present disclosure, which may be used in combination with any one or more of the preceding aspects, the method further includes determining if the operator satisfied the workflow rule by determining if a time the operator resides in the area exceeds a predetermined threshold.

In accordance with a tenth aspect of the present disclosure, which may be used in combination with any one or more of the preceding aspects, the method further includes determining if the operator satisfied the workflow rule by comparing motions of the operator to predetermined motions.

In accordance with an eleventh aspect of the present disclosure, which may be used in combination with any one or more of the preceding aspects, the method further includes determining if the operator satisfied the workflow rule by determining if a tool being used by the operator is specified by the workflow rule.

In accordance with a twelfth aspect of the present disclosure, which may be used with the eleventh aspect in combination with any one or more of the preceding aspects, the tool includes an identifier that is detectable in the video to enable the identifier to be referenced to the workflow rule.

In accordance with a thirteenth aspect of the present disclosure, which may be used in combination with any one or more of the preceding aspects, the workflow rule includes a distribution of data from pervious instances of operators completing the inspection test.

In accordance with a fourteenth aspect of the present disclosure, which may be used in combination with any one or more of the preceding aspects, the workflow rule is determined based on a layout of the inspection area.

In accordance with a fifteenth aspect of the present disclosure, which may be used in combination with any one or more of the preceding aspects, at least one of the video or the depth data is stored to a database if the operator did not satisfy the workflow rule.

In accordance with a sixteenth aspect of the present disclosure, which may be used in combination with any one or more of the preceding aspects, a system is provided to operate the method accordingly to any one or more of the preceding claims.

In accordance with a seventeenth aspect of the present disclosure, which may be used in combination with any one or more of the preceding aspects, a workflow process control and monitoring method includes: (a) enabling an operator to initiate an inspection from within an inspection area remote from a camera system; (b) enabling the operator to initiate a first procedure of the inspection from within the inspection area; (c) causing the camera system to determine if the operator moves to a location within the inspection area that is appropriate for the first procedure; (d) obtaining a result for the first procedure; and (e) enabling steps (b) to (d) to be repeated for a second procedure of the inspection.

In accordance with an eighteenth aspect of the present disclosure, which may be used with the seventeenth aspect in combination with any one or more of the preceding aspects, the workflow process control and monitoring method further includes causing the camera system to identify a tool used by the operator.

In accordance with a nineteenth aspect of the present disclosure, which may be used with the seventeenth aspect in combination with any one or more of the preceding aspects, the workflow process control and monitoring method further includes causing the camera system to observe markers on a tool used by the operator to analyze movement of the tool.

In accordance with a twentieth aspect of the present disclosure, which may be used with the seventeenth aspect in combination with any one or more of the preceding aspects, the workflow process control and monitoring method further includes causing the camera system to observe a directional indicator presented by the operator to conduct at least an aspect of the first procedure.

In accordance with a twenty-first aspect of the present disclosure, which may be used with the seventeenth aspect in combination with any one or more of the preceding aspects, the workflow process control and monitoring method further includes causing the camera system to analyze at least one of a color or a shape of an object inspected by the operator, for at least one (i) object identification or (ii) to control at least one aspect of the inspection.

In accordance with a twenty-second aspect of the present disclosure, which may be used with the seventeenth aspect in combination with any one or more of the preceding aspects, the workflow process control and monitoring method further includes obtaining a result for the first procedure includes using a microphone to detect a sound produced during the first procedure.

In accordance with a twenty-third aspect of the present disclosure, which may be used with the twenty-second aspect in combination with any one or more of the preceding aspects, the workflow process control and monitoring method further includes structuring the camera system to analyze the sound.

In accordance with a twenty-fourth aspect of the present disclosure, which may be used with the seventeenth aspect in combination with any one or more of the preceding aspects, the inspection is one (i) an automobile inspection, (ii) a manufacturing inspection, (iii) a service provider inspection, or (iv) a delivery inspection.

In accordance with a twenty-fifth aspect of the present disclosure, which may be used with the seventeenth aspect in combination with any one or more of the preceding aspects, the workflow process control and monitoring method further includes enabling the operator to initiate the inspection (i) verbally, (ii) by sending a sound signal or (iii) by sending a visual signal.

In accordance with a twenty-sixth aspect of the present disclosure, which may be used with the seventeenth aspect in combination with any one or more of the preceding aspects, the workflow process control and monitoring method further includes enabling the operator to initiate the first procedure of the inspection (i) verbally, (ii) by sending a sound signal or (iii) by sending a visual signal.

In accordance with a twenty-seventh aspect of the present disclosure, which may be used with the seventeenth aspect in combination with any one or more of the preceding aspects, the workflow process control and monitoring method further includes providing feedback to the operator that the inspection has been initiated.

In accordance with a twenty-eighth aspect of the present disclosure, which may be used with the seventeenth aspect in combination with any one or more of the preceding aspects, the workflow process control and monitoring method further includes providing feedback to the operator that the first procedure of the inspection has been initiated.

In accordance with a twenty-ninth aspect of the present disclosure, which may be used with the seventeenth aspect in combination with any one or more of the preceding aspects, the workflow process control and monitoring method further includes in (c) causing the camera system to determine if the operator moves to the location within a specified period of time.

In accordance with an thirtieth aspect of the present disclosure, which may be used with the seventeenth aspect in combination with any one or more of the preceding aspects, the workflow process control and monitoring method further includes causing the camera system to determine if the operator remains at the location appropriate for the first procedure for a period of time specified to complete the first procedure.

In accordance with an thirty-first aspect of the present disclosure, which may be used with the seventeenth aspect in combination with any one or more of the preceding aspects, the workflow process control and monitoring method further includes causing the camera system to verify that the operator performs an action specified for the first procedure while residing at the location appropriate for the first procedure.

In accordance with a thirty-second aspect of the present disclosure, which may be used with the seventeenth aspect in combination with any one or more of the preceding aspects, obtaining the result for the first procedure includes causing the camera system to observe the result.

In accordance with a thirty-third aspect of the present disclosure, which may be used with the seventeenth aspect in combination with any one or more of the preceding aspects, obtaining the result for the first procedure additionally includes obtaining a confirmation from the operator.

In accordance with a thirty-fourth aspect of the present disclosure, which may be used with the seventeenth aspect in combination with any one or more of the preceding aspects, obtaining the result for the first procedure includes enabling the camera system to receive a signal from the operator.

In accordance with an thirty-fifth aspect of the present disclosure, which may be used with the thirty-fourth aspect in combination with any one or more of the preceding aspects, the workflow process control and monitoring method further includes receiving the result signal audibly from the operator, via a sound signal sent by the operator, or via a visual signal sent by the operator.

In accordance with a thirty-sixth aspect of the present disclosure, which may be used with the seventeenth aspect in combination with any one or more of the preceding aspects, the workflow process control and monitoring method further includes in (e), enabling steps (b) to (d) to be repeated for a N number of total procedures for the inspection.

In accordance with a thirty-seventh aspect of the present disclosure, which may be used with the seventeenth aspect in combination with any one or more of the preceding aspects, the workflow process control and monitoring method further includes at least one of alarming or logging if in (c) the camera system does not determine that the operator moves to the location appropriate for the first procedure.

In accordance with a thirty-eighth aspect of the present disclosure, a system is provided to perform the workflow process control and monitoring method according to the seventeenth aspect in combination with any one or more of the preceding aspects.

In accordance with a thirty-ninth aspect of the present disclosure, which may be used in combination with any one or more of the preceding aspects, a medical system includes a camera system including a digital camera, at least one processor and at least one memory configured to operate collectively to observe a patient, analyze the data from the observation, and provide the analyzed data in a form useable by a medical professional.

In accordance with a fortieth aspect of the present disclosure, which may be used with the thirty-ninth aspect in combination with any one or more of the preceding aspects, the digital camera, the at least one processor and the at least one memory are configured to observe movements of the patient, analyze the movements, and provide the analyzed movements in a form useable to the medical professional.

In accordance with a forty-first aspect of the present disclosure, which may be used with the thirty-ninth aspect in combination with any one or more of the preceding aspects, the at least one processor and the at least one memory are configured to analyze the movements according to a set of instructions specific to a sleep disorder.

In accordance with a forty-second aspect of the present disclosure, any of the concepts, methodology and structure discussed and illustrated in connection with any one or more of FIGS. 1A to 1D, FIGS. 2 to 4, FIGS. 5 and 6, FIGS. 7 to 9, FIGS. 10A, 10B, 11, and FIG. 12 may be used with any one or more of the preceding aspects.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A workflow evaluation system comprising:
a camera located at a facility, the camera positioned to record video data of multiple instances of a procedure involving an action performed on a workpiece at the facility, the action involving a physical movement;
a database storing at least one workflow rule concerning the procedure, at least one of the workflow rules involving the physical movement of the action performed on the workpiece; and
a procedure monitoring processor communicatively coupled to the database and configured to
access the at least one workflow rule involving the physical movement of the action performed on the workpiece,
compare corresponding physical movement information obtained from the video data of one of the multiple instances of the procedure to the accessed at least one workflow rule, and
send a non-satisfy message if the compared corresponding physical movement information does not satisfy the accessed at least one workflow rule.

2. The workflow evaluation system of claim 1, which includes a depth sensor configured to record depth data regarding the action performed on the workpiece, and wherein the corresponding physical movement information is obtained from the video data and the depth data.

3. The workflow evaluation system of claim 2, wherein a three-dimensional representation of the video data is created using the distance data and a shading of pixels within the video data, and wherein the corresponding physical movement information is obtained from the three-dimensional representation.

4. The workflow evaluation system of claim 1, which further includes a microphone recording audio data, and wherein the procedure monitoring processor uses the audio data in combination with the video data.

5. The workflow evaluation system of claim 1, wherein the database stores at least one additional workflow rule specifying a minimum or maximum duration regarding the action performed on the workpiece, and wherein the procedure monitoring processor is further configured to (i) access the at least one workflow rule specifying the minimum or maximum duration and (ii) compare corresponding action duration information obtained from the video data of the instance of the procedure to the accessed at least one minimum or maximum duration rule.

6. The workflow evaluation system of claim 5, wherein the procedure monitoring processor is further configured to send a non-satisfy message if the compared corresponding action duration information does not satisfy the accessed at least one minimum or maximum duration rule.

7. The workflow evaluation system of claim 6, wherein the non-satisfy message for the minimum or maximum duration rule is different than the non-satisfy message for the physical movement rule.

8. The workflow evaluation system of claim 5, further comprising a statistical processor configured to create at least one of the minimum or maximum duration rule or the physical movement rule prior to the use of the minimum or maximum duration rule or the physical movement rule, respectively, by the inspection monitoring processor, the creation of the minimum or maximum duration rule or the physical movement rule based on at least one of a regulatory specification, common know-how, best practices, or a statistical analysis of previously collected video data.

9. The workflow evaluation system of claim 1, wherein the procedure monitoring processor is further configured to repeat the accessing, comparing, and sending if needed for each of the multiple instances of the procedure involving the action performed on the workpiece at the facility.

10. The workflow evaluation system of claim 9, wherein each instance of the procedure involves a different workpiece.

11. The workflow evaluation system of claim 9, wherein at least two instances of the procedure involve the same workpiece.

12. The workflow evaluation system of claim 1, which is configured to prevent a next instance of the procedure involving the action performed on the workpiece until the at least one workflow rule for the current procedure is satisfied.

13. The workflow evaluation system of claim 1, wherein the workpiece is an automobile and the action involves an inspection action performed by an inspector on the vehicle.

14. The workflow evaluation system of claim 1, wherein the workpiece is a medical procedure and the action involves an inventory of surgical equipment used with the medical procedure.

15. The workflow evaluation system of claim 1, wherein the at least one workflow rule involving the physical movement of the action performed on the workpiece concerns movement of a tool applied to or utilized in the workpiece.

16. The workflow evaluation system of claim 1, wherein the at least one workflow rule involving the physical movement of the action performed on the workpiece concerns movement of a worker relative to the workpiece.

17. The workflow evaluation system of claim 1, wherein the at least one workflow rule is formed via feedback from prior video data obtained from the camera.

18. A workflow evaluation system comprising:
a camera located at a facility, the camera positioned to record video data of multiple instances of a procedure involving an action performed on a workpiece at the facility;
a database storing at least one workflow rule concerning the procedure, at least one of the workflow rules involving a minimum or maximum duration regarding the action performed on the workpiece; and
a procedure monitoring processor communicatively coupled to the database and configured to
access the at least one workflow rule involving the minimum or maximum duration of the action performed on the workpiece,
compare corresponding action information obtained from the video data of one of the multiple instances of the procedure to the accessed at least one workflow rule, and
send a non-satisfy message if the compared corresponding action information does not satisfy the accessed at least one workflow rule.

19. The workflow evaluation system of claim 18, wherein the at least one workflow rule involving the minimum or maximum duration regarding the action includes a duration of an instrument applied to the workpiece.

20. The workflow evaluation system of claim 18, wherein the at least one workflow rule involving the minimum or maximum duration regarding the action includes a duration of the action performed on the workpiece.

21. The workflow evaluation system of claim 18, wherein the at least one workflow rule involving the minimum or maximum duration regarding the action includes a duration of a worker being within a certain proximity of the workpiece.

22. The workflow evaluation system of claim 18, wherein the at least one workflow rule is formed via feedback from prior video data obtained from the camera.

23. A workflow evaluation system comprising:
a camera located at a facility, the camera positioned to record video data of multiple instances of a procedure involving a worker working on a workpiece at the facility;
a database storing at least one workflow rule concerning the procedure, at least one of the workflow rules involving a proximity of the worker to the workpiece; and
a procedure monitoring processor communicatively coupled to the database and configured to
access the at least one workflow rule involving the proximity of the worker to the workpiece,
compare corresponding worker proximity information obtained from the video data of one of the multiple instances of the procedure to the accessed at least one workflow rule, and
send a non-satisfy message if the compared corresponding worker proximity information does not satisfy the accessed at least one workflow rule.

24. The workflow evaluation system of claim 23, which includes a depth sensor operating with the camera to form the worker proximity information.

25. The workflow evaluation system of claim 23, wherein the workpiece is a portion of a larger workpiece assembly.

26. The workflow evaluation system of claim 23, wherein the at least one workflow rule is formed via feedback from prior video data obtained from the camera.
